(19) United States
(12) Patent Application Publication
(10) Pub. No.: US 2024/0244014 A1
(43) Pub. Date: Jul. 18, 2024

(54) METHODS, ARCHITECTURES, APPARATUSES AND SYSTEMS DIRECTED TO NETWORK PROGRAMMING

(71) Applicant: InterDigital Patent Holdings, Inc., Wilmington, DE (US)

(72) Inventors: Xavier De Foy, Kirkland (CA); Shamim Rahman, Cote St. Luc (CA); Ulises Olvera-Hernandez, Saint-Lazare (CA)

(21) Appl. No.: 18/289,710

(22) PCT Filed: May 6, 2022
(86) PCT No.: PCT/US2022/027992

§ 371 Date: Nov. 6, 2023

(30) Foreign Application Priority Data
May 7, 2021 (EP) 21172837.3

(51) Int. Cl. H04L 49/00; H04L 45/74

(52) U.S. Cl. CPC H04L 49/70; H04L 45/74

(57) ABSTRACT

Procedures, methods, architectures, apparatuses, systems, devices, and computer program products directed to network programming are disclosed herein. In an embodiment, a method for operating a user network program on a WTRU/UPF, comprises: A method for operating a user network program on a WTRU/UPF, the method comprising: deploying a network program instance based on a network program including network information elements (IEs); receiving a data packet from a source; associating IEs with the data packet; forwarding the data packet to the network program instance; upon reception of a data packet from the network program instance, retrieving IEs associated with the data packet; and forwarding the data packet to a destination according to the IEs. forwarding the data packet to a destination according to the IEs.

### BACKGROUND

The present disclosure is generally directed to the fields of communications, software and encoding, including, for example, methods, architectures, apparatuses, systems directed to network programming.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref.”) in the Figures indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of a use case of a deployment of a user network programs in a network;

FIG. 3 is a diagram illustrating an example of a user network program mechanisms in wireless transmit/receive units (WTRUs) and network functions;

FIG. 4 is a sequence diagram illustrating an example of an operation of a user network program in WTRU and network function;

FIG. 5 is a diagram illustrating an example of a route selection policy (URSP) rule;

FIG. 6 is a diagram illustrating an example of a network service header (NSH) and metadata fields;

FIG. 7 is a sequence diagram illustrating an example of a controlling sessions procedure from a WTRU or a network function;

FIG. 8 is a sequence diagram illustrating an example of a deployment and operation of a user network program on a WTRU;

FIG. 9 is a sequence diagram illustrating an example of the deployment and operation of a user network program on a network function; and

FIG. 10 is a flow chart illustrating an example of a method for operating a user network program on a WTRU or on a base station.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

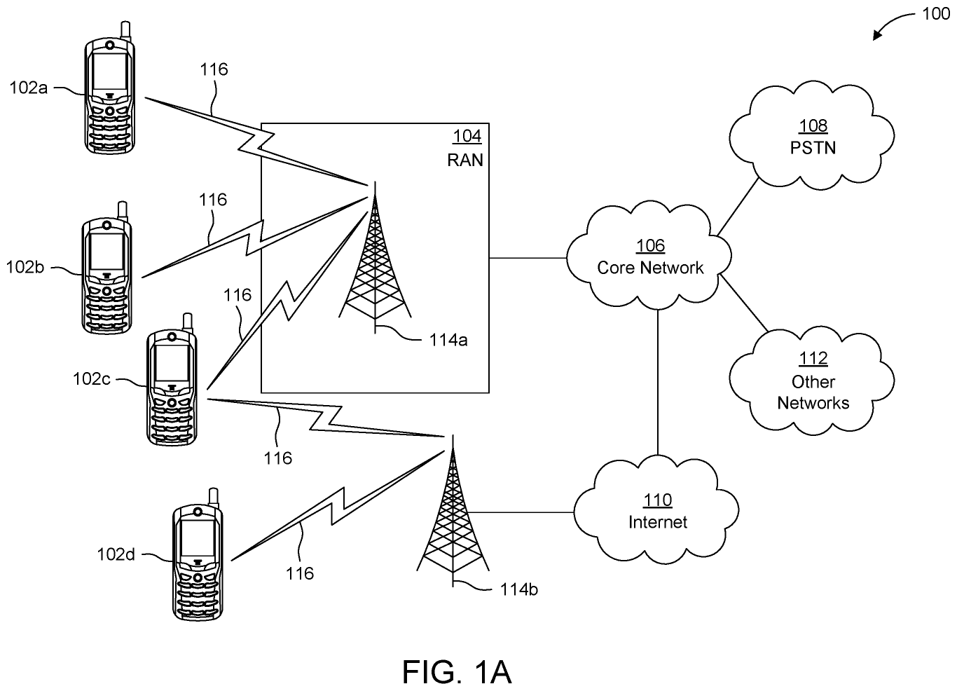

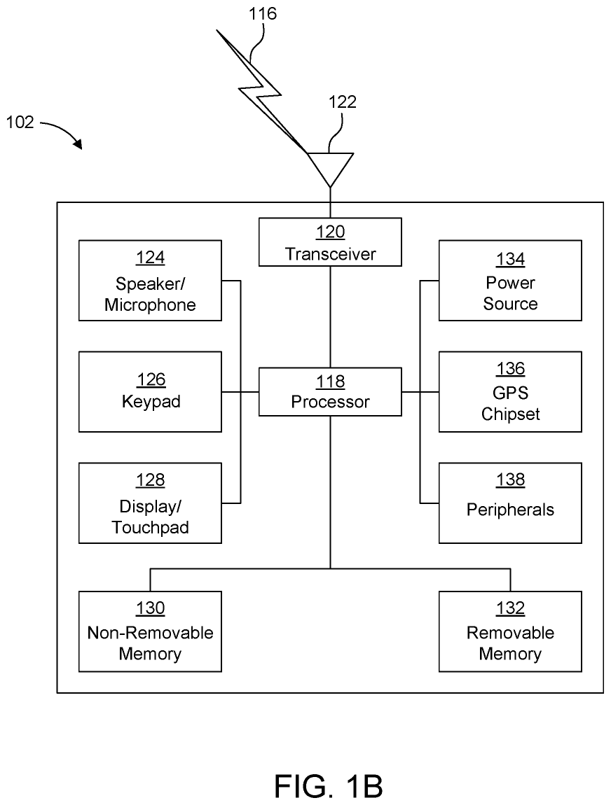

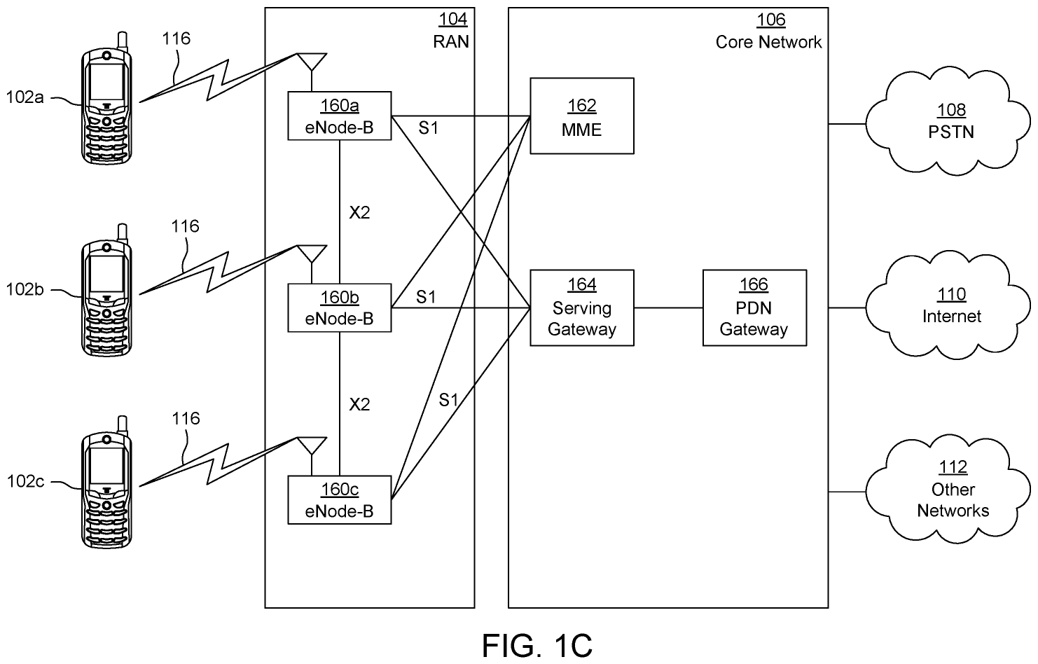

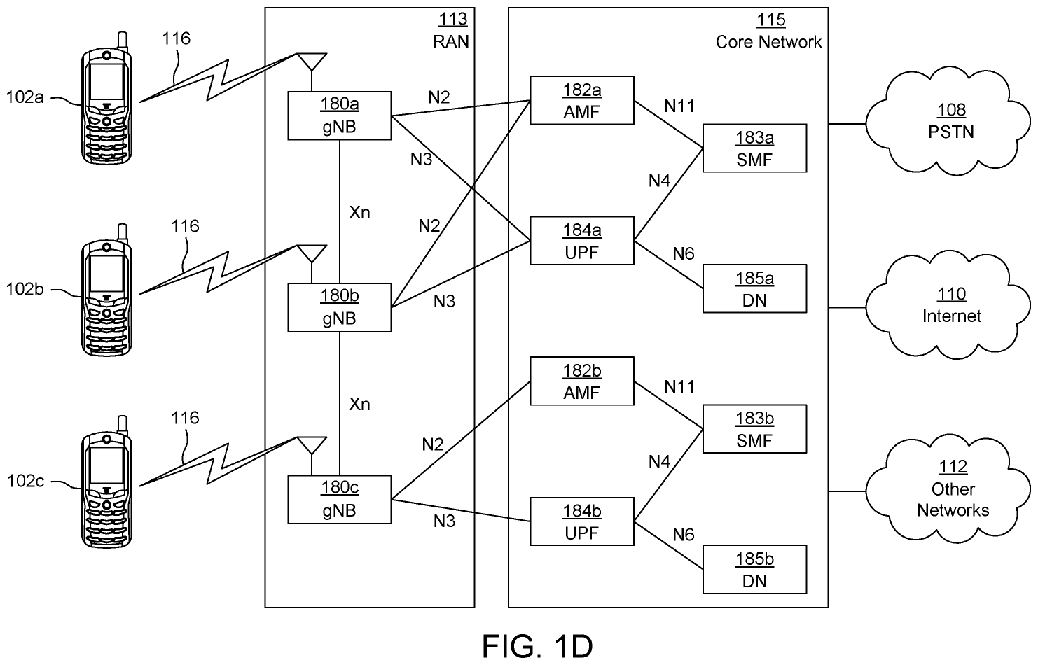

The methods, apparatuses and systems provided herein are well-suited for communications involving both wired and wireless networks. Wired networks are well-known. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram of an example communications system 100 in which one or more disclosed embodiments may be implemented. Example communications system 100 is provided for the purpose of illustration only and is not limiting of the disclosed embodiments. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA

(OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronic device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. Example WTRU 102 is provided for the purpose of illustration only and is not limiting of the disclosed embodiments. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. For example, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules/units that provide additional features, functionality and/or wired or wireless connectivity. For example, the peripherals 138 may include an accelerometer, an e-compass, a satellite transceiver, a digital camera (e.g., for photographs or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram of the RAN 104 and the CN 106 according to another embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The core network 106 shown in FIG. 1C may include a mobility management gateway (MME) 162, a serving gateway (SGW) 164, and a packet data network (PDN) gateway 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The SGW 164 may be connected to each of the eNode-Bs 160a, 160b, 160c in the RAN 104 via the SI interface. The SGW 164 may generally route and forward user data packets to/from the WTRUs 102a, 102b, 102c. The SGW 164 may also perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different packet data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

Procedures, methods, architectures, apparatuses, systems, devices, and computer program products for carrying out network programming in a communications system are disclosed herein.

### Network Programming

Network programming may refer to programming of one or more target network devices (e.g., UPFs) and/or one or more target WTRUs, where the target WTRUs may include gateways, (e.g., residential gateways, customer premise equipment), an IoT network gateways (e.g., a personal IoT network gateways), smartphones, and other types of WTRUs operating or not operating as gateways. The network programming may include, for example, programing of a data plane of one or more of the target network devices (e.g., UPFs) and/or one or more of the target WTRUs.

Network programming may involve network programs may be developed and deployed in various devices in the communications system, including the WTRUs and/or the UPFs. Provided herein are extensions to network programming frameworks to enable network programs to influence networking (e.g., 5G networking).

A network program may originate from, be developed by and/or be deployed by a user/customer (and/or a proxy for the user) of the communications system. The user/customer may be, for example, a subscriber (e.g., a customer) of any of various network operators. The user/customer may be, for example, any of a manufacturing plant owner and/or operator, a home network owner or operator, an enterprise network operator, a private network operator, etc. The methodologies and technologies disclosed herein may enable a user/customer to program a private network (e.g., non-public network) and/or virtual network (e.g., 5G local area network (LAN) virtual network). The terms “network programs”, “user network programs” and “user provided network programs” may be used interchangeably herein.

Network programming may refer to programming of one or more network devices, such as, e.g., programming of a data plane of one or more of the network devices. The network programming may be carried out using one or more network programming frameworks. Examples of the network programming frameworks include the P4 programming language (“P4”), OpenFlow, Click router and Berkeley Extensible Software Switch.

The P4 is a domain specific language that enables programming of network switch functions in a protocol-agnostic fashion. The P4 and other network programming frameworks may be used to implement various network switching and routing tasks using protocols at different layers (e.g., layer 2 and layer 3). The programming of the network switch functions of a switch may be based on any of switch architectures utilized by a network programming framework. One of the switch architectures that may be utilized is a Protocol Independent Switch Architecture (PISA). Characteristics of the PISA may include any of:
an ability to support new or private protocol headers;
an ability to remove protocol headers from packets;
Improving visibility by collecting and reporting detailed and customized statistics;
an ability to add new features, including advanced routing, congestion control, load balancing, mitigations against some forms of attacks; and
an ability to evolve (e.g., quickly evolve) existing infrastructure equipment to support new network capabilities.

Network programming may be carried out utilizing a software defined networks (SDN) model based on OpenFlow, e.g., in addition to, or as an alternative to PISA-based programming. OpenFlow is similar to P4 in that it may enable programming of network devices. Unlike PISA, an OpenFlow switch may follow a (e.g., specific) non-programmable packet pipeline. OpenFlow may define a configuration language to set match-action tables, with a standardized set of supported protocols that can be matched, and a standardized set of actions that can be applied to matched packets. A standard P4 implementation currently exist for an OpenFlow switch. OpenFlow is supported by many vendors, and commonly deployed in various SDN.

A SDN controller may be used along with one or more of the network programming models (sometimes referred to as network programming architectures). The SDN controller may be a network function that may communicate with a network switch to provide configuration information and/or to exchange one or more packets. The SDN controller may exchange packets with the network switch, for example, to allow the SDN controller to make a decision on a first packet of a flow, which in some scenarios may result in the SDN controller setting/providing additional and/or different configuration information.

Network programming languages may be compatible with network devices. As a non-limiting example of network programming language, P4 may be compatible with network devices. A P4-enabled network device may be loaded with a compiled P4 program The P4-enabled network device may execute the compiled P4 program to process packets that are received on one or more input ports of the P4-enabled network device. The P4-enabled network device may be (e.g., typically) configured with various tables and/or various objects, e.g., by one or more controllers over (via) a P4 runtime Application Programming Interface (API). The P4-enabled network device may use a portable switch architecture (PSA) (or other embodiment the PISA) and may process packets through an ingress pipeline. The ingress pipeline may include any of a parser, an ingress block, and a deparser. The P4-enabled network device may buffer one or more of the packets exiting from the ingress pipeline in at least one buffer. The P4-enabled network device may process each packet exiting from the ingress pipeline (and/or exiting the buffer) through one or more egress pipelines; replicating any packet that is to be processed through more than one egress pipeline. Any (e.g., each) of the egress pipelines may include any of a parser block, an egress block and a deparser block.

Parsers may (e.g., typically) identify headers (e.g., permitted headers) within received packets and may define how to extract specific fields from those packets, leaving the rest of the packet (e.g., payload) unexamined. Ingress/egress blocks may (e.g., typically) implement the logical operations to use and/or set metadata (e.g., to record and/or participate in forwarding decisions). Ingress/egress blocks may (e.g., typically) construct headers. Deparsers may (e.g., typically) construct an outgoing packet by reassembling headers that were computed by an earlier block.

A P4 program may target a switch architecture (also referred to as a switch programming model) such as a PSA. A switch architecture/programming model may (e.g., typically) describe one or more packet paths through a pipeline. A switch architecture/programming model may describe (specify, indicate, include information from which to determine, etc.) one or more functions and/or one or more variables (e.g., metadata) exposed by the model to the program. A program targeting a (e.g., a particular) switch architecture/programming model may be deployed on any hardware platform and/or software platform that implements the (e.g., the particular) switch architecture/programming model. Another example of switch architecture/programming model a multi-tenant portable switch architecture (MTPSA).

In network programming (e.g., in P4), metadata may be associated with a packet. to convey information between function blocks and an underlying switch platform. Intrinsic metadata may be set and read by a network device/switch, as well as by network program code. User metadata may be set and read (e.g., only set and/or only read) by network program code. In a network programming framework such as OpenFlow, intrinsic metadata may be provided using a (e.g., pseudo) header associated with a packet. The intrinsic metadata/the (e.g., pseudo) header may be used to convey information between a network device and a program. As an example, the network device may set the input port identifier (ID) of a packet as metadata. The program may assign a value to an output port ID metadata field to allow (or ensure) the network device may (e.g., properly) send the packet through a specific port.

On the other side, user metadata may be used to convey information between different blocks of a network program. As an example, a program may set a user metadata field in one block, and later use the user metadata field in another block, invoked later in the pipeline processing of the packet, to make a forwarding decision.

Network programming may be used by network operators to configure their network. P4 may be used to implement complex functions, such as encapsulating traffic over GTP tunnels, where the tunnel ID is determined by an external controller. With OpenFlow and P4, network programs can be deployed as part of the fabric of an operator's network, e.g., programmed in switches or router hardware.

5G Local Area Network (LAN) is a feature of a 5G network that may enable WTRUs (members) of a virtual 5G LAN group to communicate with each other as if they were part of a LAN. 5G LAN may support IP and Ethernet-type PDU sessions. 5G LAN VN group may (e.g., only) be associated with a single Data Network Name (DNN) and a Single Network Slice Selection Assistance Information (S-NSSAI).

As part of the management of Non-Public Network (NPN) (e.g., a standalone NPN (SNPN) or Public Network Integrated NPN (PNI-NPN)), a 5G network operator may collect WTRU related data, such as Minimization of Drive Test (MDT) data (e.g., including WTRU location, as well as layer-2 and layer-3 measurements at WTRU and attachment point). A 5G network operator may provide the WTRU related data to the NPN service customer (e.g., an enterprise).

Another management task may consist in managing virtual networks (VN) groups under the direction of a NPN service customer, where the customer may create, modify, or remove VN groups, add and remove a WTRU from VN groups, and where the 5G network operator may forward events related to VN groups towards the NPN service customer.

### Examples of Use Cases of Network Programming

The following use cases may describe how network programming by users/customers may enable tailoring security, routing, level of service and/or reporting, e.g., in a granular way.

### Use Case #1: Configuration of a Non-Public Network (NPN) or 5G LAN Inside a Plant

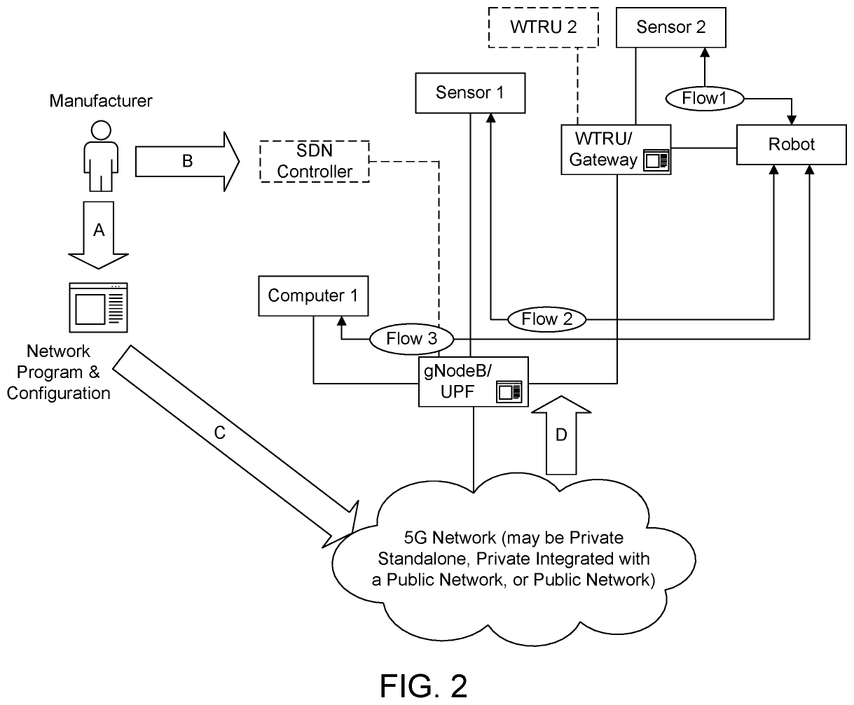

Referring to FIG. 2, a customer, denoted as a manufacturer herein, operating a plant, may decide to interconnect various plant equipment using a 5G LAN. The customer may customize the 5G LAN VN according for various reasons. For example, the customer may customize the behavior of the 5G LAN VN based on any of:
Customized security rules, e.g., to ensure that only connections between specific equipment is allowed, and/or only using pre-authorized protocols.
Customized levels of services, e.g., including low latency between specific pieces of equipment and/or several levels of services based on protocols, peers, or WTRU identities (e.g., to ensure automation control, video, interactive and file transfer traffic are handled adequately).
Customized forwarding/routing decisions. Forwarding/routing decisions may depend on network load, source/destination addresses, network failures, time of day, user/customer decision at runtime (e.g., duplicate specific flows for audit/security reason when decided by user/operator, e.g., forward over different paths based on dynamic load balancing).
Customized reports for traffic statistics through network nodes (e.g., detailed throughput, latency, jitter measurements for some specific flows only, and possibly based on dynamic decisions by user/operator).

The customized behaviors may be influenced in real-time by the 5G customer, e.g., through an SDN controller or through a SDN controller application of a WTRU.

At step A, the customer may develop one or more network program. The network programs may be, as non-limiting example, any of a P4 program and its configuration, a set of OpenFlow match-actions tables, and other types of network programs.

Steps B, C and D, are related to the deployment on the network programs in devices of the 5G LAN/NPN. At step B, the customer may in some cases deploy a SDN controller to configure and control the network programs. In some other cases, the customer may rely on the 5G network to configure and control the network programs. The customer may deploy a SDN controller as regular application on a WTRU. At step C, the customer may provision the network program(s) into the 5G network. At step D, the 5G network may configure the network program(s) on devices, such as an UPF (e.g., collocated in a gNode-B in an embodiment) a target WTRU acting as a gateway, etc. The devices may be in one or more manufacturing sites and may be in 5G public or private networks.

Traffic between network nodes may be forwarded (e.g., selectively forwarded) through the network programs that have been instantiated (“network program instances”). In a WTRU and a UPF, the traffic may be sent (e.g., selectively sent) through the locally deployed network program instances. All or part of the traffic associated with the NPN and/or 5GLAN VN may be identified using traffic filters. The traffic filters may include any of a source/destination MAC or IP addresses, a DNN, a S-NSSAI, application name, a 5G LAN VN group ID, a closed access group, and a network identifier. All or part of the traffic associated with the NPN and/or 5GLAN VN may be forwarded to the appropriate network program instance on the WTRU/UPF. The network program instance may perform any task as per its program. The task may include any of forwarding an initial packet to a controller, counting packets of the traffic, dropping one or more packets, duplicating one or more packets, associating one or more packets with a new DNN or S-NSSAI, and selecting a PDU session type. Traffic that is not dropped by the network program may be further forwarded towards its destination.

Network programs may behave as network functions that process traffic passing through them. The network programs may implement any of customized security rules, levels of services, and forwarding decisions and reports. As a non-limiting example, according to FIG. 2, pursuant to the network programs, flow 1 and flow 2 (identified by peers, protocols, etc.) may be provided a high level of service. Pursuant to the network programs, detailed report regarding flow 1 and flow 2 may be produced by the network program instances at the WTRUs/UPFs, and may be provided from the network program instances at the WTRUs/UPFs to a monitoring application on computer 1 or to an external controller if present. Pursuant to the network programs, flow 1 and flow 2 may be provided with alternative routes in case of failure (e.g., through other devices not shown in FIG. 2). Pursuant to the network programs, flow 3 may be provided a lower level of service. Any new unknown traffic may trigger an alert from devices to the monitoring application on computer 1 or on SDN controller.

Network programs may enable SDN control of a WTRU relay in a 5GLAN VN or NPN context. As a non-limiting example, a network program instance on the WTRU/gateway (e.g., the WTRU/gateway shown in FIG. 2) may forward towards a SDN controller a first packet of a flow originated from a WTRU 2, e.g., carried by a plant worker, and relayed through the WTRU/gateway. The SDN controller may reply to the network program instance with an indication to apply a customer-specific behavior on the flow. The customer-specific behavior may include any of a drop, collecting information, applying a specific QoS, and using a specific network slice.

### Use Case #2: Configuration of a Personal IoT Network (PIN) or Residential Network

In PIN networks, a WTRU may operate as a gateway and may enable PIN devices (e.g., wearable IoT devices) to communicate with each other and to an outside network (e.g., the Internet). In a residential network, a WTRU may act as a gateway for home devices, e.g., as an enhanced residential gateway. A user/customer may deploy a network program on a WTRU/gateway to configure custom PIN/home network connectivity rules, including security rules (e.g., allow only certain protocols or peer addresses per individual device) and/or level of service rules (e.g., use specific level of services for specific protocols/peers/local devices combinations).

### Use Case #3: Configuration of a Non-IP Virtual Network

User-programmable network programs may enable non-IP protocols to be deployed over a 5G LAN VN using unstructured PDU sessions. 5G LAN VN may not support unstructured PDU sessions. A user/customer may deploy network programs over a (e.g., new) unstructured PDU session-based 5G LAN VN to implement Information Centric Networking (ICN) routers. In a case where implementing an ICN router is too complex to be practically implemented in a network program, implementation of the ICN router may be split in two components. The first component may be a network program implementing a fast path, and the second component may be a controller program implementing a slow path. A controller program may include an application on a WTRU, or a centralized controller controlled by the customer.

According to the use cases described above, network programming by users/customers (e.g., SDN programming of 5G system (5GS) elements by users) may enable (e.g., some cases real-time) the tailoring of performance reporting, security, routing, level of service, in a granular way. Pursuant to the methodologies and technologies disclosed herein, user network programming and/or the enabling of tailoring of performance reporting, security, routing, level of service by user network programming are made possible without the cost of a massive added complexity in the 5G management plane. Network programming may enable customization. As a non-limiting example, network programming by the users/customers may go beyond a one-to-one (1:1) mapping between DNN/S-NSSAI and a 5G LAN VN group, wherein a differentiated service between flows in a 5G LAN VN is prevented.

Another advantage of network programming by the users/customers may be to align, from network management perspective, networks with wired and wireless networks, where vertical (e.g., enterprise/industrial/home) network operators may use network programming. Support for user-provided network programming may enable vertical network operators to transparently switch between communication technologies (e.g., from in-house solution using network programming to a 5GLAN).

Network programming by users/customers may support single and distributed network device cases. For example, a user/customer may deploy a network program on a single UPF in a single-site 5GLAN, or a single WTRU in a single-site PIN. In multi-site 5GLAN VN or other virtual network cases, a user/customer may deploy network programs on multiple UPFs and/or WTRUS.

Network programming frameworks may have to support network protocols such as PDU sessions and their associated parameters. A network program may be aware of input and output ports (e.g., corresponding to physical ports). For example, in a WTRU, a network program may be aware of a network interface and a Wi-Fi network interface. Network programming frameworks (e.g., including P4 and OpenFlow) may enable manipulation of networking parameters. As non-limiting-example, a network program including 5G-awarness features described herein may enable 5G-specific operations, such as dynamically specifying 5G QoS of flows, using PDU session parameters for taking decisions, etc.

### User Network Program in WTRUs and UPFs

A (e.g., 5G) network operator may provision/deploy and may operate/utilize user network program instances on (e.g., 5G) devices, such as one or more WTRUs and/or one or more UPFs. The network programs instances may be provisioned on the WTRUs/UPFs in association with a configuration information. The configuration information may include various information including and/or indicating any of a configuration of the network program, traffic filters for input/output of the network program, an identification of the target devices, and an ID of the network program. During operation, some traffic flows may be forwarded through network program instances on the WTRUs/UPFs. A policy control function (PCF) and/or a unified data management/unified data repository (UDM/UDR) may be involved in (e.g., facilitate and/or provide resources for) storing and distributing the policies and programs. Network programs and associated configuration information may be provisioned in a (e.g., 5G) communication system by users/customers, e.g., through a network exposure function (NEF) API.

A network programming platform (e.g., a software or hardware switch/router component) may support exposing information elements (IEs) (e.g., 5G IEs) to network programs. The network programming platform may set (populate) various exposed IEs with applicable/corresponding information associated with packets at ingress of the network program instance. The applicable/corresponding information may include any of a PDU session ID, a DNN, a slide ID, a QOS ID (e.g., 5G QOS ID), a WTRU ID, etc. A network program instance may change or set any of the IEs associated with packets it processes. Packets and their associated IEs may be emitted by the network program instance back to the WTRU/UPF (e.g., 5G) stack. The WTRU/UPF may use the IEs to determine how to handle packets.

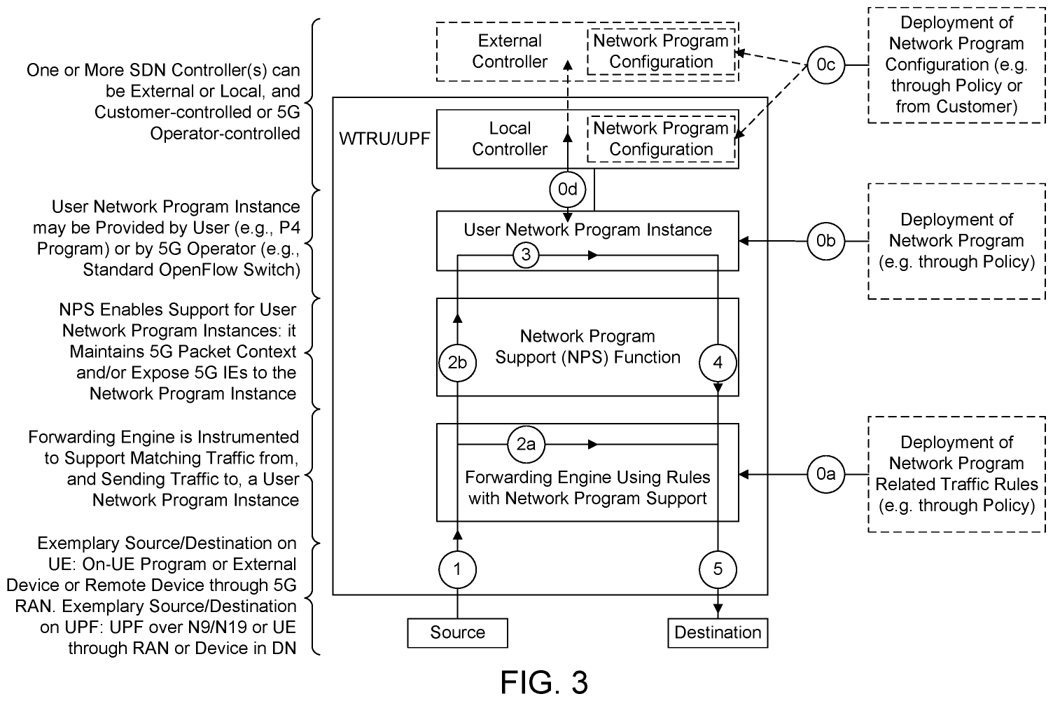

FIG. 3 is a non-limiting example of a user network program mechanism disposed in a WTRU and/or a UPF. At steps 0a, 0b, and 0c, user network program IEs are deployed in the WTRU/UPF. The user network program IEs may include any of a deployment configuration, traffic policies, a network program, and a network program configuration. At step Od, a SDN controller may connect to a network program instance and may provide the configuration information associated with the network program instance. The SDN controller may be an internal or external SDN controller.

At step 1, packets originated from a source may be passed to the WTRU/UPF. As non-limiting example, a source/destination on a WTRU may include any of an on-WTRU program, an external device, and a remote device through a 5G RAN. As non-limiting example, a source/destination on a UPF may include any of a UPF over N9/N19, a WTRU through RAN, and a device in a DN. One or more of the packets may be matched against traffic rules (e.g., on WTRU, UE route selection policy (URSP), and packet detection rule (PDR) on UPF). A traffic rule may be selected, and a corresponding action may be applied to the one or more packets.

At step 2a, if the selected rule action does not specify a network program identifier (ID), then the traffic action may be applied as usual. For example, the traffic action may be to drop or forward the packets towards a destination (step 5). For one or more packet of a flow on a WTRU, this action may include creating a PDU session.

At step 2b, if the selected rule action specifies a network program ID, then the one or more packets may be forwarded through a network program support (NPS) function. One role of the NPS may be to enable forwarding to/from the network program instance. Another role of NPS may be to maintain a link between the packets and 5G context information associated with the packet/flow (e.g., application ID, source port, PDU session, etc.). As non-limiting example, the NPS function may encapsulate the packets, e.g., in a network service header (NSH), using a service path ID associated with the network program instance ID. The NPS function may encapsulate the packets, e.g., in NSH, using a metadata field associated with a 5G context data structure. The NPS function may support network programs (e.g., 5G-aware network programs), and may exchange IEs (e.g., 5G IEs) between the WTRU/UPF and the network program instance, e.g., using NSH metadata.

At step 3, the NPS may forward the traffic to the network program instance associated with the network program ID from the selected traffic rule. At step 4, the network program instance may process the packets as per (in accordance with) its program and/or configuration information. The network program instance may communicate with an (e.g., SDN) controller as part of this processing. At step 5, the packets may be forwarded to the destination.

### Example of a Packet Processing Procedure by a Network Program Instance

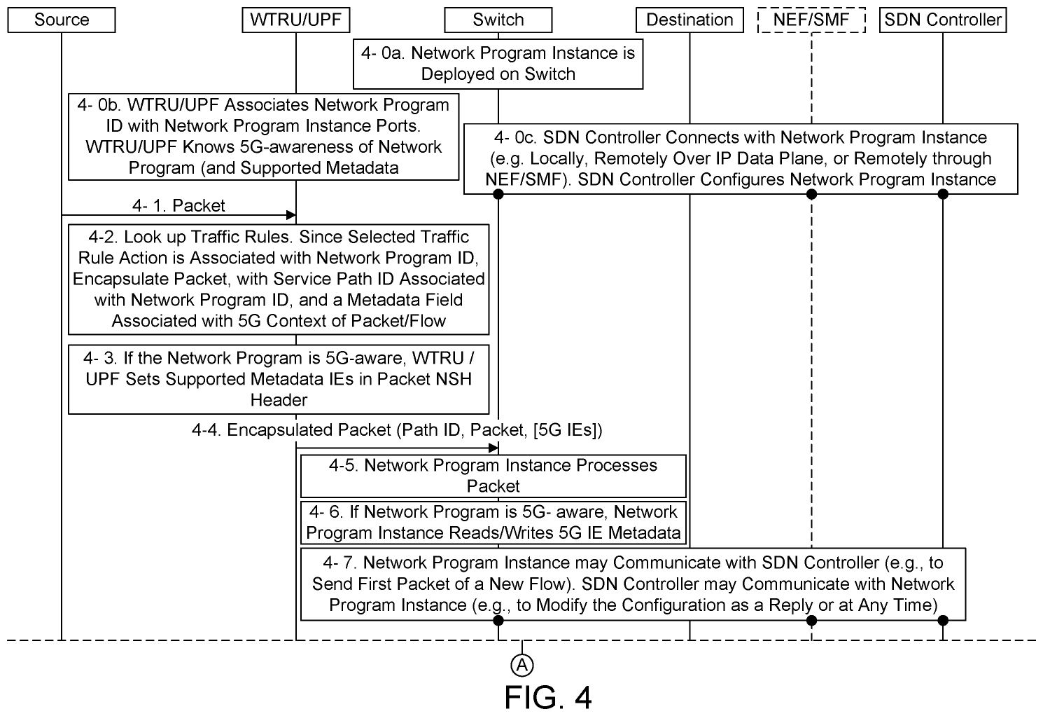

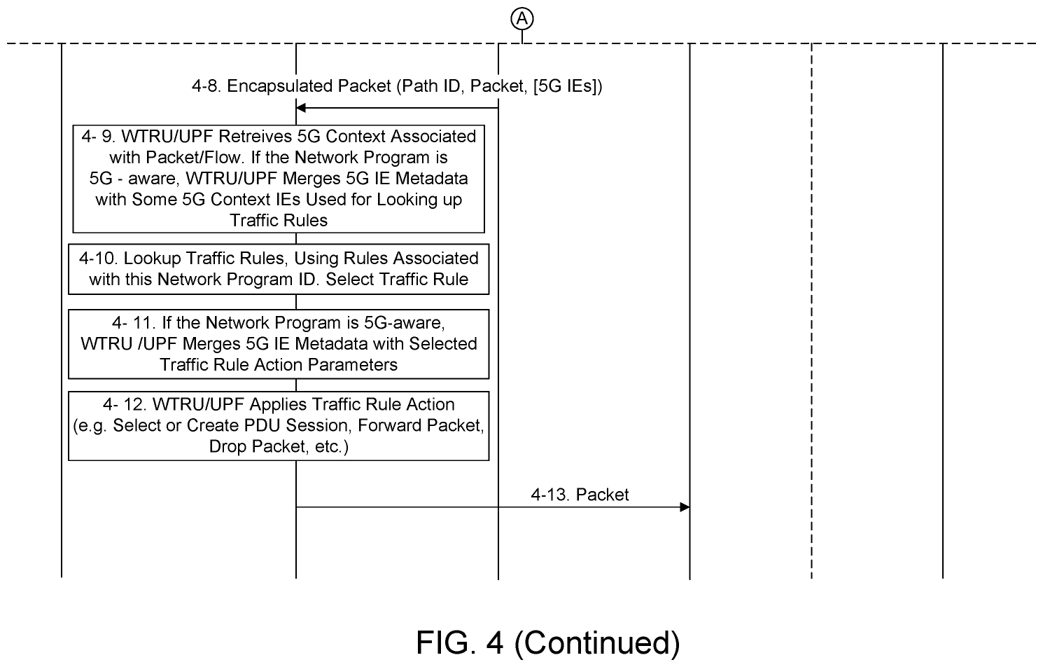

FIG. 4 is a sequence diagram illustrating an example of an operation of a user network program collocated with a WTRU or UPF. The example operation may be carried out by a WTRU or a UPF and various elements of a communications system, such as the communications system 100 of FIGS. 1A-1D. The various elements may include a source, a destination, a hardware or a software switch component, a (e.g., SDN) controller, and a NEF and/or SMF. The hardware or software switch component may be a part of the WTRU/UPF or may be a network function external from the WTRU/UPF. The (e.g., SDN) controller may be collocated with the WTRU/UPF or may be an external network function. The NEF/SMF may be a set of (e.g., 5G) network functions, which may include the NEF and/or the SMF.

### Representative Deployment of Program Instance

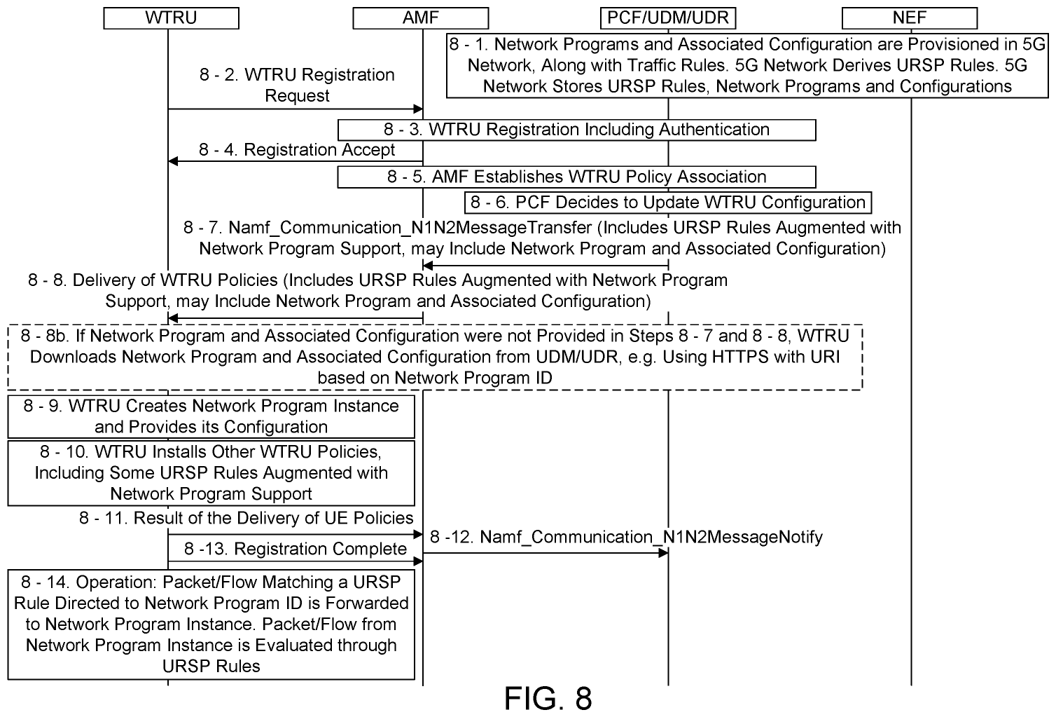

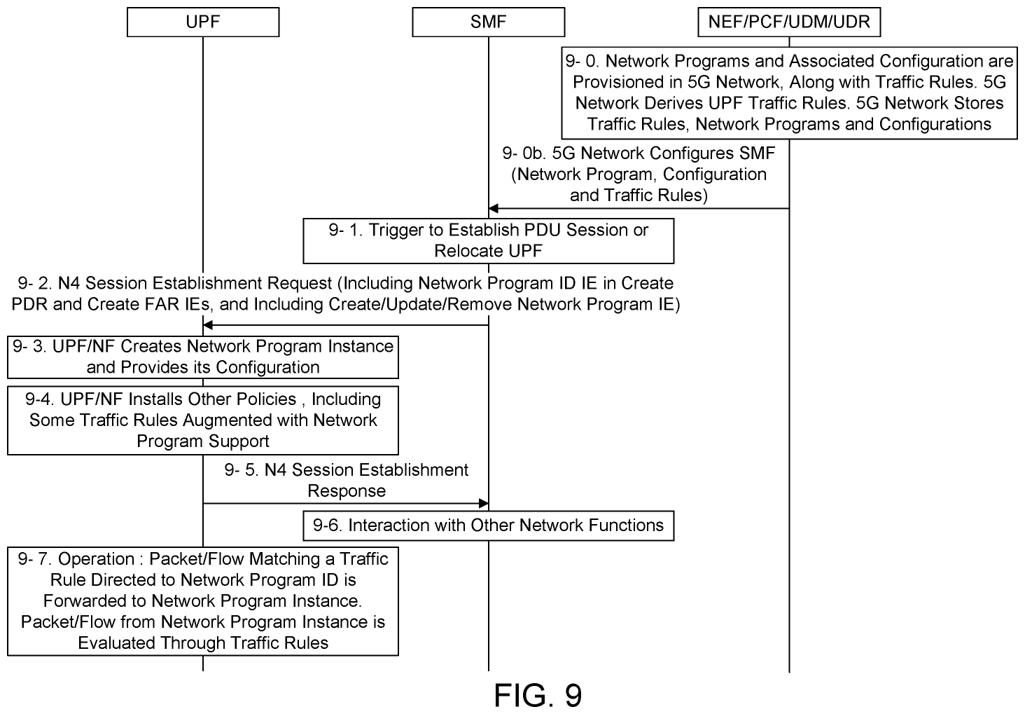

Step 4-0a is a preliminary step including the deployment of a network program instance. One or more network program IEs may be configured on the WTRU. The network program IEs may include any of a network program deployment configuration IE, a network program IE, a network program configuration IE and a network program related traffic rules IE may be configured on the WTRU. Depending on use cases, not all of the network program IEs may be present. For example, the network program IE may be omitted for an OpenFlow switch since the OpenFlow switch logic is standard. The network program configuration IE may be omitted, for example, if a configuration is provided by an (e.g., external) controller. The network program IEs may be configured by the user/customer, and then by the network (e.g., 5G) into the target WTRUS and/or UPFs, as described herein (see FIG. 8 and FIG. 9). At the end of the process of deployment, a network program instance may be running on the WTRUs/UPFs (e.g., on a P4 virtual/hardware switch component, or an OpenFlow virtual/hardware switch component), network program configuration information may be provisioned on a controller (e.g., local controller or external controller), and network program related traffic rules may be installed on the WTRU/UPF.

Splitting, or distributing, a user/customer network program into a set of individual, per-WTRU/UPF programs may be done manually by a programmer or automatically by a software system during deployment. The method of splitting/distributing the network program may enable some program logic to be (e.g., only) applied once on a path, while others (e.g., idempotent operations, or operations designed to be applied at each hop) may be applied multiple times. To enable splitting/distributing of the network program, a network operator (e.g., a 5G network operator) may provide a network model topology to the programmer (e.g., the user/customer, or provider of the program to the customer). In an example, this may be a 2-tier model, where (e.g., anchor) the UPFs may be (e.g., fully) connected nodes and the WTRUs may be leaves. In this example, the programmer (or an automated process based on a single program from the programmer) may write one program for each tier. In this example, the operator (e.g., through a local SDN controller on a WTRU/UPF) may provide, to each of the WTRUs/UPFs, a configuration table including source MAC/IP addresses of the packets that enter the first (or last) network program instance of a set. The network program instance may use the “first instance” or “last instance” information (e.g., flag) to choose which processing to apply to a (e.g., each) packet, for example, to limit certain types of processing to only cases where this information (e.g., flag) is set.

A user network program may be operated on a switch platform (e.g., switch component) collocated with a WTRU/UPF. The switch platform may implement one of multiple target architecture/programming models.

For example, a user network program may run on various target architecture/programming models:
A user network program instance may run on a (e.g., dedicated) switch (e.g., a virtual switch or a dedicated switch hardware component). As a non-limiting example, a network (e.g., 5G network) stack on a WTRU/UPF may forward traffic, to and from the switch. The traffic may be identified by traffic filters. In some cases, a traditional architecture/programming model such as PSA or an OpenFlow switch (OFS) may be used. In some cases, the host may perform (e.g., additionally perform) some adaptation between networking specific parameters and the switch, e.g., using intrinsic per-packet metadata and/or (e.g., pseudo) header as disclosed herein. The adaptation may result in one or more new capabilities being added to a base architecture/programming model. The resulting architecture/programming model may be named, e.g., 5G-PSA or 5G-OFS, depending on the architecture/programming model it is based on.
A user network program instance may run on a switch shared with other network programs, e.g., using some form of multi-tenancy mechanism, such as, e.g., MTPSA. A host functionality may be implemented in the host component of the multi-tenancy capable switch (e.g., in P4). The host component may forward packets towards user network programs based on traffic filters. After a user network program instance finishes processing a packet, the packet may be handed back to the host component. The host may (e.g., additionally) perform some adaptation between networking specific parameters using similar metadata-based techniques described herein, enabling the user network program instance to learn parameters (e.g., 5G parameters) associated with its ingress packets, and to associate parameters (e.g., 5G parameters) with its egress packets. Such a target architecture may be named, e.g., 5G-MTPSA.

### Representative Network Program Deployment Configuration IE

A network program deployment configuration IE may indicate how to deploy a network program. The network program deployment configuration IE may include any of:
A network program ID: an (e.g., unique) identifier within the communications system that may be used as reference to the network program, in IEs exchanged in procedures described herein.
A WTRU flag: an information that may indicate that the network program may be deployed on a WTRU.
UPF flag: an information that may indicate that the network program may be deployed on a UPF.
A target architecture model ID: an identifier that may indicate the type of device architecture on which the network program may run. As non-limiting example, the type of device architecture may include any of OFS, PSA, MTPSA, and a network (e.g., 5G) aware version of one of these architectures, e.g., as described herein.
A mobile-network-awareness IE (e.g., 5G-awarness IE): may be any of a boolean (e.g., true indicates the program network may supports 5G IEs), a list of supported mobile network (e.g., 5G) IEs, and a type indicating a set of supported mobile network (e.g., 5G) IEs. It may include (e.g., also include) a mobile-network-awareness (e.g., 5G-awareness) method IE that may indicate, e.g., if mobile network (e.g., 5G) IEs are provided to the user network program through NSH encapsulation, through user metadata, or through other methods.
A target type and ID. The target type may identify the type of the target ID. The type of target ID may be any of a (e.g., 5G) LAN VN group ID, a closed access group ID (e.g., identifying members of a PNI-NPN), a combination of PLMN ID and a network identifier (e.g., identifying a SNPN), a WTRU ID, list of WTRU IDs, a WTRU group ID, a virtual network ID, etc. The target type and ID together may identify targets WTRUs and/or target UPFs that the network program may be deployed in (e.g., UEs members of a specific 5GLAN VN group and UPFs that handle traffic for this 5GLAN VN group).
A controller address/name/certificates: may point to an (e.g., external) controller or a local WTRU application provided by the user/customer. A controller certificate may be used by the (e.g., 5G) mobile network to authorize access, by the controller, to the network program instance control interface. Additional certificate(s) may be provided to authenticate the network program instance(s), enabling mutual authentication to be used (e.g., using mutual transport layer security (mTLS)).
Other switch deployment configuration: it may include a list of network ports that the network switch instance should be connected to.

### Representative Network Program IE

Network program IE may be a compiled (e.g., as a JavaScript Object Notation (JSON) file in the case of P4), or uncompiled source code. If a source code is provided, the (e.g., 5G) mobile network operator may compile the source code for the (e.g., specific) targets it supports (e.g., before storage in UDM/UDR or before providing the network program to a specific WTRU/UPF). In case of using a network programming framework that relies on a standardized switch platform (e.g., OpenFlow), match-action tables may be provided in network program configuration information. The network program IE field may be empty in this case.

### Representative Network Program Configuration IE

A network program configuration IE may include tables matching parameter values, such as MAC/IP address ranges with associated actions. For example, the tables matching parameter values may be an OpenFlow-compliant set of match-action tables, or a set of configuration tables corresponding to a given P4 network program. The network program configuration IE may include (e.g., also include) a list of supported ports (e.g., Wi-Fi and cellular on a UE, N3, N9 and N6 interfaces on a UPF) and an indicator (e.g., a flag) indicating whether a port (e.g., each port) supports network programming (e.g., in accordance with the disclosure herein). The network program configuration IE may be for runtime configuration through an API (e.g., a P4 runtime API or an OpenFlow control connection).

### Representative Network Program Related Traffic Rules IE

A network program related traffic rules IE may include a traffic descriptor component. The traffic descriptor component may be used to determine if a flow matches a particular rule. The network program related traffic rules IE may include (e.g., also include) an action/route selection descriptor component. The action/route selection descriptor component may be used to determine how to process a flow that matches the traffic descriptor component. Some traffic rules may be used to determine which traffic may be forwarded to an instance of a network program. Other traffic rules may determine how to process traffic from a network program instance, e.g., using a network program ID IE.

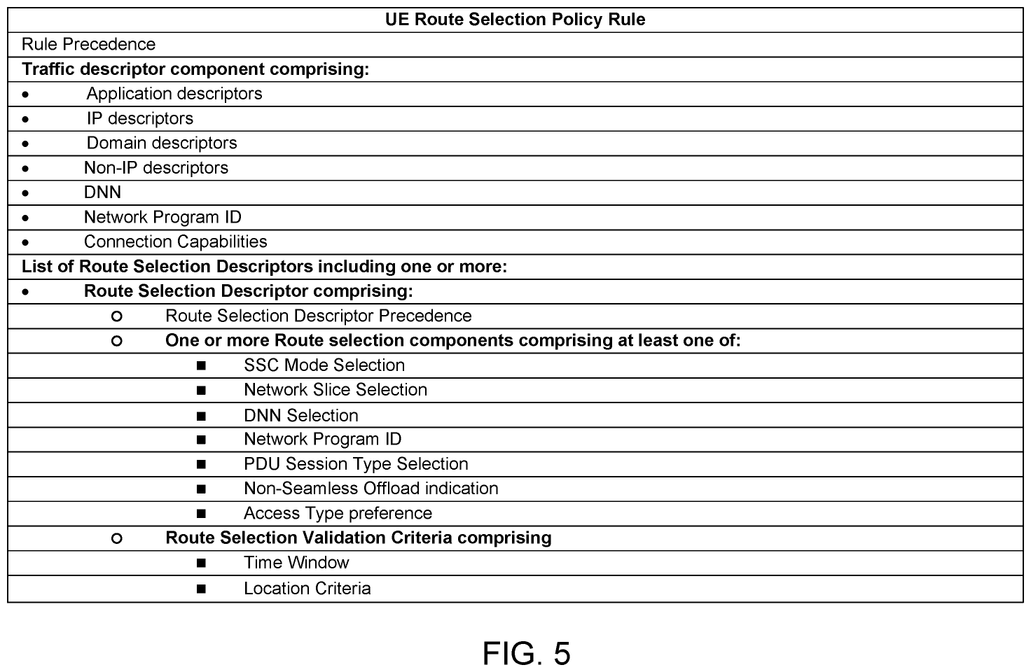

Traffic rules may be the same for all target devices. Traffic rules may be customized per target device type (e.g., a WTRU or an UPF), or per target device ID. Network program related traffic rules may be stored as URSP rules (e.g., for a WTRU), an UPF traffic rules (e.g., using IEs such as PDR, forwarding action rules (FAR), etc.), or another (e.g., similar) format. Traffic rules IEs for supporting network programs in UPFs are described herein along with a procedure in FIG. 9. URSP rules with NPS are described in FIG. 5. FIG. 5 shows a non-limiting example of a composition of a URSP rule including network program ID IEs. Other parameters described in FIG. 5 may be URSP rules IEs, such as, for example URSP rules IEs from 3GPP TS 23.503 V15.5.0 release 15.

A network program ID IE may be used in different cases:
Network program ID IE, when used in a traffic descriptor component, may indicate that (e.g., only) packets emitted by a local network program instance corresponding to an ID match this entry.
Network program ID IE, when used in a route selection descriptor, may indicate that packets matching this entry may be forwarded towards a local network program instance corresponding to the ID.

### Representative Network Program ID

At step 4-0b of FIG. 4, the WTRU/UPF may set up a relationship between the network program ID and the network program instance (e.g., its input and output ports). The WTRU/UPF (e.g., the NPS function of WTRU/UPF), may be configured to send packets corresponding to a network program ID towards the corresponding network program instance input port. The WTRU/UPF may be configured to associate a packet from a network program instance output port with a network program ID. The network program ID may be used for configuring routing/forwarding to/from the network program instance, in the WTRU/UPF and/or in the network (e.g., 5G). As a non-limiting example, the value may be programmed, as any of a virtual extensible local area network (VxLAN) port, a virtual local area network (VLAN) ID, a NSH Service Path ID, in a switch/router and/or Service Function Forwarder (SFF) function located in the WTRU/UPF or in one or more other 5G NFs. The WTRU/UPF may further determine, e.g., using a mobile-network (e.g., 5G) awareness IE provided by the user/customer, if the network program is mobile-network-aware (e.g., 5G-aware), and what mobile-network (e.g., 5G) IEs may be made available to the network program.

### Representative Controller

At step 4-0c of FIG. 4, one or more (e.g., SDN) controllers, provided by the 5G network operator and/or user/customer, may connect the network program instance, and may provide its initial configuration information (e.g., a set of action-match tables). The one or more (e.g., SDN) controllers may connect to the network program instance using a (e.g., SDN) control protocol, e.g., P4 runtime API or OpenFlow protocol, or a session control protocol such as packet forwarding control protocol (PFCP). As non-limiting example, controllers (e.g., SDN controllers) may include any of a controller (e.g., SDN controller) provided by a network (e.g., 5G) operator, a controller (e.g., SDN controller) connecting to the WTRU/UPF over a data plane provided by a customer, and a controller (e.g., SDN controller) connecting to a WTRU/UPF over a (e.g., 5G) control plane provided by a customer.

### Representative Controller Provided by a Mobile Network Operator.

A controller (e.g., SDN controller) provided by a mobile network (e.g., 5G) operator, may be collocated with a WTRU, a UPF, a SMF, or a core network NF. A controller (e.g., SDN controller) provided by a mobile network (e.g., 5G) operator may configure a network program instance using a network program configuration information (e.g., match-action tables) provided by a user/customer. To enable the configuration (e.g., when creating a new network program instance on WTRU or UPF), a mobile network (e.g., 5G) operator may configure, in the (e.g., SDN) controller, the network program configuration information as well as the address and credentials for accessing the network program instance. According to the network program configuration information, the (e.g., SDN) controller may communicate with the network program instance (e.g., using P4 runtime API or OpenFlow protocol) and may configure it.

### Controller Connecting to a WTRU/UPF Over a Data Plane Provided by a Customer

A controller (e.g., SDN controller) connecting to a WTRU/UPF over a data plane provided by a customer may be deployed on an application server, e.g., in a data network connected to a (e.g., 5G) mobile network, or may be deployed as an application running on a WTRU. The (e.g., SDN) controller may both configure network program instances and may communicate with them at runtime. The (e.g., SDN) controller may enable a common (e.g., SDN-based) control platform integrating (e.g., 5G) networking technologies by controlling both (e.g., 5G) mobile-hosted network program instances and network program instances deployed in (e.g., SDN) network devices.

To enable connectivity between the (e.g., SDN) controller and network program instance, the mobile network (e.g., 5G) operator may enable discovery of an (e.g., IP) address for control of the network program instance. As non-limiting example, an (e.g., IP) address may be provided through a network management interface or through a domain name service (DNS) system. As non-limiting example, each network program instance may be associated with a fully qualified domain name (FQDN) provided through a network management interface.

### Controller Connecting to WTRU/UPF Over a Control Plane Provided by a Customer.

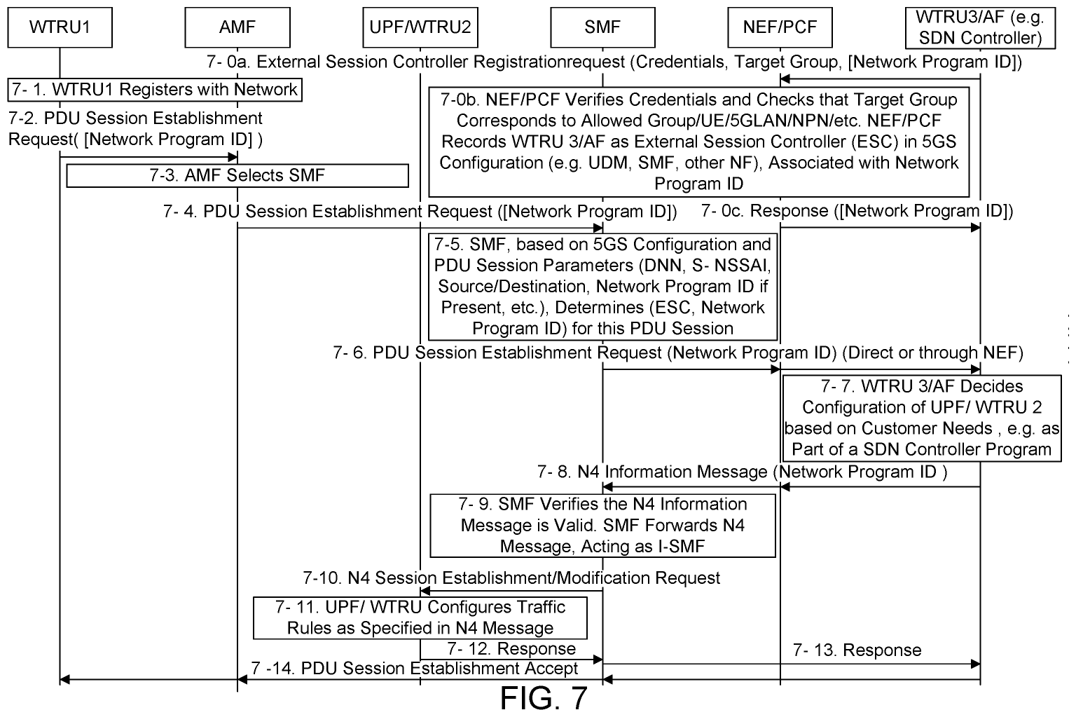

A controller (e.g., SDN controller) connecting to a WTRU/UPF over a (e.g., 5G) control plane provided by a customer may be deployed on a WTRU or on an application function (AF) connected to the network program instance, e.g., through the (e.g., 5G) control plane. As a non-limiting example, the WTRU/AF may communicate with the WTRU/UPF through an NEF/SMF, using any of OpenFlow messages, P4 runtime API messages, and PFCP messages. An exemplary procedure is presented in FIG. 7.

### Representative Initial Packet Processing

At step 4-1 of FIG. 4, the WTRU/UPF may receive a packet from a source, which may be an external network node or a program (e.g., on the WTRU).

At step 4-2 of FIG. 4, based on the received packet, the WTRU/UPF may look up traffic rules (URSP rules on a WTRU, PDR rules on an UPF) and may select a traffic rule. If the selected traffic rule action does not specify a network program ID, an action (e.g., forward the packet, drop the packet, etc.) may applied.

If the selected traffic rule action specifies a network program ID, the adaption layer of the WTRU/UPF may be configured to send the packet to the local network program instance associated with this network program ID. The configuration of the adaption layer of the WTRU/UPF may include enabling the association between the packet/flow and its mobile network (e.g., 5G) context information. The mobile (e.g., 5G) network context information may have to be preserved when the packet is sent through the network program instance. Mobile network (e.g., 5G) context information may be a set of IEs. The set of IEs may be set by the WTRU/UPF in association with packets/flow. The set of IEs may be used by the WTRU/UPF to select and/or apply traffic policy to the packet/flow. As a non-limiting example, a mobile network (e.g., 5G) context may be a data structure including IEs, such as any of an application ID, an input port, a PDU session ID, a GPRS tunneling protocol user plane (GTP-U) header fields (to enable re-encapsulating packets at UPF egress), and IEs listed below (see step 4-4 of FIG. 4), etc.

At step 4-2 of FIG. 4, the received packet may be processed according to two scenarios:
In an embodiment, which may be suitable if the network program instance is hosted on a virtual switch on a WTRU/UPF, or hosted on an external network function, the WTRU/UPF may encapsulate the packet, e.g., using an NSH header. The WTRU/UPF may associate an ID with a mobile network (e.g., 5G) context data structure. The WTRU/UPF may set a “Context/Flow ID” metadata field to this value in the NSH header. The WTRU/UPF may use a Network Program ID as Service Path Identifier (SPI) in the NSH header.
In an embodiment (not shown at FIG. 4), which may be suitable if user network program instances are run on a multitenant switch (e.g., MTPSA or 5G-MTPSA), the WTRU/UPF may set a (e.g., 5G) mobile network context ID and/or mobile network (e.g., 5G) per-packet/flow IEs as user metadata associated with the packet. The WTRU/UPF may encapsulate the packet within a VLAN or VxLAN header, e.g., using a Network Program ID as VxLAN port or VLAN ID.

### Representative NPS Function

At step 4-3 of FIG. 4, the WTRU/UPF may determine if the network program associated with the target network program ID is mobile-network (e.g., 5G) aware. If it is not, the packet processing procedure by the network program instance may jump to step 4-4. If it is (e.g., 5G) mobile-network-aware, the NPS function may associate mobile network (e.g., 5G) IEs per-packet/flow metadata with the packet at the ingress of the network program instance. IEs per-packet/flow metadata may be any mobile network (e.g., 5G) IE which is known by the WTRU/UPF to be associated with a packet/flow, e.g., its source application ID and others. In a first example, if NSH encapsulation is used, the NPS may set mobile network (e.g., 5G) IEs per-packet/flow metadata as NSH metadata. In a second example, if user metadata is used (not shown on FIG. 4), then the NPS may set (e.g., 5G) mobile network IEs per-packet metadata as user metadata.

At step 4-4 of FIG. 4, the packet may be transmitted to the user network program instance. In an embodiment, if NSH encapsulation is used, then the NPS may send the encapsulated NSH packet to the input port of the user network program instance, or to an SFF. In another embodiment second example, if user metadata is used, then the NPS may enqueue the packet to the input port of the user network program instance (e.g., input port corresponding to the network program ID). The WTRU/UPF may transmit to the switch, the packet, its associated mobile network (e.g., 5G) context ID (e.g., as NSH or user metadata holding the context ID), and any mobile network (e.g., 5G) IE per-packet/flow metadata (e.g., as NSH metadata or user metadata).

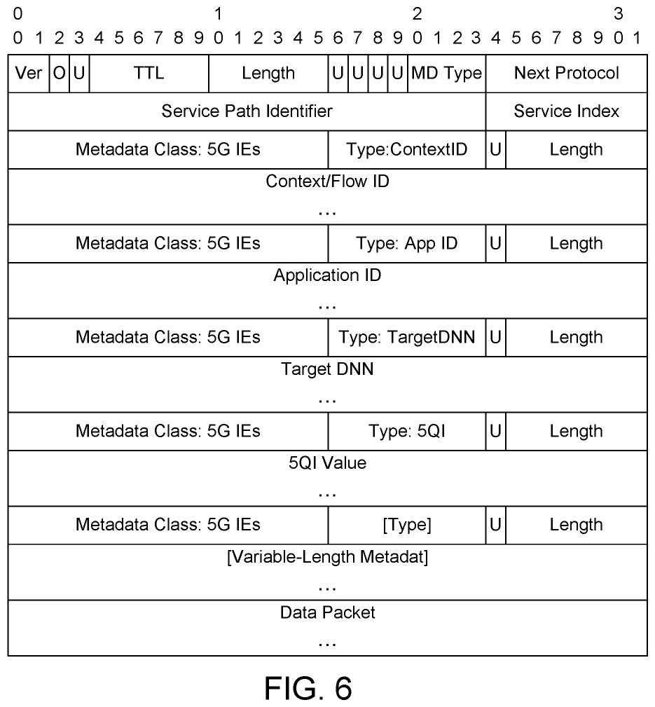

FIG. 6 is an example of a NSH and metadata fields. More particularly, FIG. 6 represents a base NSH base including the following fields:
‘Ver’ for version;
‘O’ for Operations Administration and Maintenance (OAM);
‘U’ for unused bits;
‘Length’ for NSH header length;
‘MD Type’ for metadata type (e.g., 2 for variable-length metadata);
‘Next Protocol’;
‘Service Path Identifier’

The base NSH may be followed with NSH metadata IEs. NSH metadata IEs may include a metadata class (e.g., a new metadata class identifying per-packet/flow 5G IEs), a metadata type, unused bit, length, and a metadata value. The SPI may be used by the WTRU/UPF to associate a network program ID with a packet. Metadata types may be defined for holding a mobile network (e.g., 5G) context data structure ID and each individual mobile network (e.g., 5G) per-packet/flow IE. A Maximum Transmission Unit (MTU) of the link between a WTRU/UPF and the network program instance (e.g., a virtual, wireless, or physical link) may be set to a high value to enable NSH encapsulation to be performed without requiring IP fragmentation.

In an embodiment, the mobile network (e.g., 5G) per-packet IEs may include any of:
Mobile network (e.g., 5G) per-packet/flow IEs for selection of a traffic rule: (e.g., including URSP rule entries (e.g., well-known URSP rule entries) and PFCP IEs)
   Application descriptors (e.g., application ID)
   IP descriptors
   Domain descriptors (e.g., domain name)
   Non-IP descriptors
   Data network name (DNN) for selection
   Connection Capabilities
   Source WTRU ID (e.g., GPSI, IMSI, IMEI, MSISDN) or group ID
   Destination WTRU ID (e.g., GPSI, IMSI, IMEI, MSISDN) or group ID
Mobile network (e.g., 5G) per-packet/flow IEs corresponding to a traffic rule action: (e.g., including URSP rule entries (e.g., well-known URSP rule entries) and PFCP IEs)
   Session and Service Continuity Mode
   Target DNN
   PDU session type
   Access Type preference, e.g., device interface type (e.g., N9, N19, N3, N6 interface on UPF, cellular or Wi-Fi interface on UE)
   PDU session ID
   Network slice (e.g., S-NSSAI)
   Level of service (e.g., observed 5G QoS identifier (5QI) value for ingress packet, desired 5QI value for egress packet)

The mobile network (e.g., 5G) per-packet/flow IEs listed above may be used as ingress and/or egress packet-level/flow (e.g., 5G) IEs associated with packets to/from a network program instance, using any method described herein such as NSH header or user metadata. Mobile network (e.g., 5G) per-packet/flow IEs may also be called 5G IEs or 5G IE metadata herein. Some mobile network (e.g., 5G) per-packet/flow IEs may be read-only by a network program (e.g., a source WTRU ID may typically not be changeable by the network program), and some IEs may be available only on a WTRU or UPF (e.g., application ID may be available on a WTRU).

In an embodiment, the mobile network (e.g., 5G) per-packet/flow IEs may be (e.g., only) provided to the network program instance with a first packet of a flow. The network program instance may process the packet and may communicate with an SDN controller. The SDN controller may configure the network program instance in a configuration entry for the flow. The entry may include a network program ID and/or context/flow ID to identify the flow, and/or values of mobile network (e.g., 5G) per-packet/flow IEs that apply to this flow. The WTRU/UPF may forward subsequent packets of the flow in an NSH header including the service path ID, but without including mobile network (e.g., 5G) per-packet/flow IE metadata.

User network programs may support mobility of a WTRU and mobility of an end device connected through a WTRU. A (e.g., SDN) controller may use a mobile network (e.g., 5G) API and may register to receive WTRU mobility events. The (e.g., SDN) controller may setup a first flow in a first user network program instance. When a second user network program instance (e.g., in another UPF or WTRU) receives an unexpected packet (e.g., a packet mid-flow), it may send it to the (e.g., SDN) controller. The (e.g., SDN) controller may determine that this packet belongs to the first flow (e.g., because it has the same context ID, and/or PDU session ID, and/or source WTRU ID, etc.). The (e.g., SDN) controller may configure the second user network program instance to handle the flow, e.g., using parameters initially used to configure the first flow.

In an embodiment, the WTRU/UPF may communicate with a multi-tenant switch. The WTRU/UPF may set the NSH service path ID to the value of the network program ID prior to sending NSH-encapsulated packets to the switch supporting multi-tenancy (e.g., using a MTPSA architecture). The host component of the switch may remove the NSH header, set user metadata fields using the mobile network (e.g., 5G) context/flow ID and mobile network (e.g., 5G) per-packet/flow IEs from the NSH header. The host component of the switch may forward the packet, e.g., encapsulated in VLAN or VxLAN, to one of its user network program instances identified using the network program ID (e.g., using a network program ID as VxLAN port or VLAN ID). The user network program may process the packet, possibly reading and writing user metadata. The user network program may enqueue a packet resulting from this processing. The host component of the switch may dequeue the packet. The host component of the switch may remove the VxLAN header and may add a NSH header using user metadata to fill NSH metadata fields. Additionally, when a multi-tenant switch is used, a (e.g., SDN) controller that may be operated by a (e.g., 5G) mobile network operator, may configure the host component of the switch (e.g., to add table entry associating a new user program with a network program ID). The (e.g., SDN) controller that may be operated by a customer, may configure a user/tenant program from the customer (e.g., add new rules for each time there is a new flow).

### Representative Processing in Network Program Instance

At step 4-5 of FIG. 4, the network program instance (e.g., OpenFlow, P4, or another network program instance) may process the packet. The network program instance may decide to drop the packet or to forward the packet, to perform encapsulation, to update measurement counters, forward to a (e.g., SDN) controller, etc.

At step 4-6 of FIG. 4, if the network program instance is mobile-network (e.g., 5G) aware, it may use mobile-network (e.g., 5G) per-packet/flow IE metadata (set in step 4-3), to influence packet processing. A mobile-network (e.g., 5G) aware network program instance may also set/change mobile-network (e.g., 5G) per-packet/flow IE metadata value to influence subsequent packet processing by the mobile-network (e.g., 5G) stack. When NSH is used, the platform/switch may extract metadata from the NSH header, expose them as intrinsic metadata or (e.g., pseudo) header fields to the network program to read/set them, and/or reassemble the NSH header from this metadata/fields for egress packets. Alternatively, the NSH header may be exposed directly to the network program instance, which can read NSH metadata on ingress packets and/or set NSH metadata on egress packets.

A non-limiting example of a P4 source code illustrating a type of 5G-aware processing that may be perform on an exemplary 5G-PSA architecture is depicted below. The network program depicted below defines a table that may be used to select the network slice (S-NSSAI) of IPv4 packets based on the destination address.

```
#include <core.p4>
#include <v1model.p4> /* includes a definition of standard_metadata_t structure */
typedef bit<48> EthernetAddress;
typedef bit<32> IPv4Address;
header ethernet_t {
  EthernetAddress dst_addr;
  EthernetAddress src_addr;
```

| | |
|---|---|
| bit<16> | ether_type; |

}
header ipv4_t {

| | |
|---|---|
| bit<4> | version; |
| bit<4> | ihl; |
| bit<8> | diffserv; |
| bit<16> | total_len; |
| bit<16> | identification; |
| bit<3> | flags; |
| bit<13> | frag_offset; |
| bit<8> | ttl; |
| bit<8> | protocol; |
| bit<16> | hdr_checksum; |

```
  IPv4Address src_addr;
  IPv4Address dst_addr;
}
struct headers_t {
  ethernet_t ethernet;
```

| | |
|---|---|
| ipv4_t | ipv4; |

```
}
struct metadata_t {
}
error {
  IPv4IncorrectVersion,
  IPv4OptionsNotSupported
}
parser my_parser(
  packet_in packet,
  out headers_t hd,
  inout metadata_t meta,
  inout standard_metadata_t standard_meta)
{
state start {
  packet.extract(hd.ethernet);
  transition select(hd.ethernet.ether_type) {
```

| | |
|---|---|
| 0x0800: | parse_ipv4; |

```
  default: accept;
  }
}
state parse_ipv4 {
  packet.extract(hd.ipv4);
  verify(hd.ipv4.version == 4w4, error. IPv4IncorrectVersion);
  verify(hd.ipv4.ihl == 4w5, error. IPv4OptionsNotSupported);
  transition accept;
  }
}
control my_deparser(packet_out packet,
```

in headers_t hdr)

```
{
apply {
  packet.emit(hdr.ethernet);
  packet.emit(hdr.ipv4);
  }
}
control my_verify_checksum(
  inout headers_t hdr,
  inout metadata_t meta)
}
  apply { }
}
control my_compute_checksum(
  inout headers_t hdr,
  inout metadata_t meta)
{
  apply { }
}
control my_ingress(
  inout headers_t hdr,
  inout metadata_t meta,
  inout standard_metadata_t standard_metadata)
{
  bool dropped = false;
  action drop_action( ) {
      mark_to_drop(standard_metadata);
      dropped = true;
    }
    action to_slice_action(bit<16> snssai) {
      hdr.ipv4.ttl = hdr.ipv4.ttl − 1;
      standard_metadata.egress_spec = 0; /* egress to port 0 */
      standard_metadata.snssai = snssai; /* associate packet with given S-NSSAI */
    }
    table ipv4_match {
      key = {
        hdr.ipv4.dst_addr: lpm; /* IPv4 network address is used as key to this table */
      }
      actions = {
        drop_action;
        to_slice_action;
      }
      size = 1024;
      default_action = drop_action;
    }
    apply {
      ipv4_match.apply( );
      if (dropped) return;
    }
}
control my_egress(
  inout headers_t hdr,
  inout metadata_t meta,
  inout standard_metadata_t standard_metadata)
{
  apply { }
}
V1Switch(my_parser( ),
  my_verify_checksum( ),
  my_ingress( ),
  my_egress( ),
  my_compute_checksum( ),
  my_deparser( )) main;
```

A non-limiting example of a 5G-aware intrinsic metadata fields added to standard data structure of intrinsic metadata in PSA architecture is illustrated below. The 5G-aware intrinsic metadata fields may be used by the network program depicts above.

struct standard_metadata_t {
/* This data structure includes intrinsic metadata fields for a PSA architecture */

| | |
|---|---|
| PortId_t | ingress_port; |
| PortId_t | egress_spec; |
| PortId_t | egress_port; |

```
  /* Other existing intrinsic metadata fields are omitted for brievity */
  /* The following fields are added as examples of 5G-aware intrinsic metadata fields */
```

| | |
|---|---|
| bit<16> | snssai; /* S-NSSAI (using a fixed length of 16 bits as an example) */ |
| varbit<504> | application_id; /* Application ID (using a variable size of 63 octets or |

less as an example) */

| | |
|---|---|
| bit<8> | pdu_session_type; /* PDU session type (using a fixed length of 8 bits as an |

example) */

| | |
|---|---|
| varbit<504> | dnn; /* DNN (using a variable size of 63 octets or less as an example) */ |

/* ... (additional network program 5G IEs can be defined, as described herein) */

A non-limiting example of configuration entries, using an exemplary command line scripting interface, for the network program depicts above may be illustrated as follow:
   # The first table entry associates N-SSAI 3 (e.g., a Massive IoT slice) for traffic towards this IP range
   table_add ip4_match to_slice_action 10.10.0.0/16=>3
   # The second table entry associates N-SSAI 2 (e.g., a URLLC slice) for traffic towards this IP range
   table_add ipv4_match to_slice_action 11.11.0.0/16=>2
   # The third table entry causes to drop packets associated with this IP range
   table_add ipv4_match drop_action 20.20.20.0/24=>

### Representative End of Processing in Network Program Instance

At step 4-7 of FIG. 4, the network program instance may communicate with a (e.g., SDN) controller (e.g., when processing a packet matching a catch-all rule for new flows). The communication between the network program and the (e.g., SDN) controller may use protocols such as OpenFlow, P4 runtime protocol, PFCP, and may be transported over a data plane connection (e.g., a PDU session), an internal connection in the WTRU/UPF, or a (e.g., 5G) control plane such as described in FIG. 7.

At step 4-8 of FIG. 4, the network program instance may transmit the packet and associated metadata (e.g., service path ID, 5G context ID, and 5G per-packet/flow IEs metadata) to the WTRU/UPF. The WTRU/UPF (e.g., the NPS function of a WTRU/UPF) may read the packet and may re-associate a (e.g., 5G) mobile network context data structure with the packet. As non-limiting example, the packet may be encapsulated in a NSH header: NPS may re-associate a (e.g., 5G) mobile network context data structure using a context/flow ID metadata field of the NSH header, and the NPS may obtain, for usage in subsequent steps, any mobile network (e.g., 5G) per-packet/flow IE metadata from NSH header. The NSH header, if used, may be removed by the NPS at this point.

In another non-limiting example, e.g., in a MTPSA-like architecture, the WTRU/UPF, e.g., the host component of the multi-tenant switch, may have direct access to metadata associated with packets from the user network program instance. The WTRU/UPF may have direct access to mobile network (e.g., 5G) context/flow ID and mobile network (e.g., 5G) per-packet/flow IE metadata associated with the packet, for usage in subsequent steps.

### Representative Reinjection and Merging

At step 4-9 of FIG. 4, the WTRU/UPF may retrieve mobile network (e.g., 5G) context associated with packet/flow, e.g., using context/flow ID. If the network program is mobile-network (e.g., 5G) aware, the WTRU/UPF (e.g., the NPS function of a WTRU/UPF) may merge some mobile network (e.g., 5G) per-packet/flow IEs with mobile network (e.g., 5G) context IEs, with a purpose of preparing for selecting a traffic rule at step 10. For example, when looking up traffic rules, any mobile network (e.g., 5G) per-packet/flow IE for selection of a traffic rule, as listed above at step 4-4, may be used, if set by the network program instance. Otherwise, the original value from the mobile network (e.g., 5G) context of packet/flow may be used. In an example, a packet sent from application with ID “app-id-1” may have its application ID replaced with “app-id-2” by the network program. The application ID “app-id-2” may be used to select a traffic rule. The NPS may sort mobile network (e.g., 5G) per-packet/flow IEs modified by the network program instance: for example, if the network program instance sets an unauthorized Application ID, then NPS may ignore this value.

At step 4-10 of FIG. 4, the WTRU/UPF may select a traffic rule to handle the packet/flow.

Step 4-11 of FIG. 4 is executed if the network program is mobile-network (e.g., 5G) aware. The WTRU/UPF may merge some mobile network (e.g., 5G) per-packet/flow IEs with traffic rule action parameters based on a merging algorithm. As non-limiting example, parameters of a selected URSP rule in a WTRU, or selected FAR rule in an UPF, may be merged with mobile network (e.g., 5G) per-packet IEs corresponding to a traffic rule action as listed above at step 4-4. Merging algorithm may differ based on implementation and parameter. As a non-limiting example, if a target DNN mobile network (e.g., 5G) per-packet/flow IE is included in the DNN selection list of the rule, the target DNN mobile network (e.g., 5G) per-packet/flow IE may be used to replace the DNN selection of a URSP rule. A merging algorithm may enable control, by the mobile network (e.g., 5G) operator, of the DNNs that may be set by a network program, which improves security. A merging algorithm may be used for network slices (N-SSAI). For fields which do not have a list (e.g., PDU session type), an example of secure merging algorithm may be to use a selected rule action parameter if specified, and otherwise may use the corresponding mobile network (e.g., 5G) per-packet IE if available. In case of some mobile network (e.g., 5G) per-packet/flow IEs corresponding to a traffic rule action may not correspond to a URSP/FAR rule action (e.g., PDU session ID or level of service), the mobile network (e.g., 5G) stack may use the mobile network (e.g., 5G) per-packet/flow IE to modify the action, e.g., select a specific PDU session ID, or use a specific mobile network (e.g., 5QI) level of service for the packet/flow.

At step 4-12 of FIG. 4, the WTRU/UPF may apply a selected traffic rule action. The selected traffic rule action may include forwarding a packet over an existing PDU session, as illustrated by step 4-13, to a destination. The selected traffic rule action may include (e.g., also include) dropping the packet. For an initial packet of a flow on a WTRU, the selected traffic rule action may include creating a PDU session.

### Representative Example of Deployment on a Network Function (NF)

In an embodiment, the network program instance may be deployed in an NF (e.g., dedicated NF). For example, a UPF may run network programs. When a PDU session is created, the (e.g., 5G) mobile network (e.g., the SMF function) may determine if a network program is associated with this PDU session. If it is the case, SMF may configure and may insert a UPF dedicated to network programs, as an intermediate UPF (I-UPF) between the RAN and the PSA UPF. As a non-limiting example, the (e.g., dedicated) UPF may be a P4 enabled switch implemented using MTPSA. An SMF may configure the P4 switch with table entries linking mobile network (e.g., 5G) IEs with PDU session tunnel header (e.g., GTP-U header) field(s). The P4 switch, after receiving a data packet, may parse the PDU session tunnel header. The P4 switch may further obtain related mobile network (e.g., 5G) IEs. The P4 switch may associate the 5G mobile network (e.g., 5G) IEs as user metadata to the data packet it enqueues for a user network program instance. The network program instance may process the packet. The network program instance may enqueue the packet back towards the host. The host may forward the packet towards a destination as per its traffic rules.

### Representative Security Considerations

A network operator may control input and output traffic to and from a network program. As a non-limiting example, to limit the risks from deploying network programs on a WTRU and/or a UPF, the mobile network (e.g., 5G) operator may apply restrictions on input/output of a network program, since it may control the traffic rules associated with any given network program ID. The traffic rules may filter traffic that is sent towards a network program instance (ingress rules), and traffic that is emitted by a network program instance (egress rules), as illustrated in FIG. 3. For example, the mobile network (e.g., 5G) operator may determine that egress traffic rules may (e.g., only) accept traffic that is directed towards specific IP addresses, DNN, N-SSAI, etc.

A network operator may restrict the right to deploy a network program on specific WTRUs and UPFs. As a non-limiting example of a restriction, only authorized mobile network (e.g., 5G) users/customers may be allowed to deploy a network program on a specific set of devices. The restriction may be based on parameters configured in the customer's subscriber profile (e.g., parameters such as 5G LAN VN ID, CAG, etc. . . ). The user's/customer's subscriber profile may be set through a provisioning API.

A network operator may apply restrictions on the network program and its configuration information. As a non-limiting example of a restriction, at provisioning time, the network operator may apply limit on the acceptable size of a network program and its configuration information. As a non-limiting example of a restriction, at runtime, the network operator may limit the amount of memory and processing made available to the network program instance by a host operating system.

A network operator may authorize access, from a (e.g., SDN) controller in a data network or on a WTRU, to the network program instance control interface. For example, an operator may implement a secure control channel, e.g., remote procedure call (gRPC) channel for P4 runtime API on a WTRU and a UPF or a SMF, using transport layer security (TLS) authentication and possibly mTLS authentication. Such a secure control channel may offer a centralized or distributed control interface to network program instances.

A network operator may provide access, by a (e.g., SDN) controller, to the network program instance control interface through its control plane. As a non-limiting example, a SMF, directly or through a NEF, may expose an (e.g., OpenFlow, P4 runtime or PFCP) interface to a (e.g., SDN) controller. This makes it possible for the NEF/SMF to authenticate the SDN controller, and to relay SDN commands between the (e.g., SDN) controller and the network program instance. Additionally, the NEF/SMF may analyze OpenFlow/P4 runtime/PFCP messages for security rules (e.g., allow only certain DNNs and S-NSSAIs to be specified in rules).

Example of a Controlling Sessions Procedure from a WTRU or an AF

FIG. 7 is a non-limiting example of a sequence diagram of a procedure where a WTRU or AF (e.g., a SDN controller running on a WTRU or an AF) may control traffic rules associated with PDU sessions associated with any of a (e.g., 5G) LAN, a NPN, a WTRU, and a WTRU group. In this embodiment, a network program instance distinct from the WTRU/UPF mobile network (e.g., 5G) stack may not be necessary. The user/customer may (e.g., directly) program the behavior of some PDU sessions, using the network programming capabilities offered by the PFCP protocol on a N4 interface. A UPF/WTRU2 may designate a common UPF, or a UPF implemented in a WTRU. A (e.g., SDN) controller program running on a WTRU3/AF may provide SMF-like functionality to control traffic between members of a (e.g., 5G) LAN VN group, members of a NPN, or other groups of WTRUs.

At step 7-0a, the WTRU3/AF may send an external session controller (ESC) registration request to NEF/PCF. This request may include credentials, and a target group. The target group may be any of a WTRU group, a WTRU ID, a list of WTRU IDs, a (e.g., 5G) LAN VN ID, a NPN ID (e.g., closed access group (CAG) group or network identifier). The registration request may include (e.g., also include) a network program ID, although, alternatively, according to step 7-0c, a NEF/PCF may generate this network program ID and provide it back to the WTRU3/AF in a response message.

At step 7-0b, the NEF/PCF may determine if the WTRU3/AF is allowed by the mobile network (e.g., 5G) operator to act as an ESC for this target group, e.g., based on a business agreement between a customer and (e.g., 5G) the network operator. If the request is accepted, the NEF/PCF may record, in mobile network system (e.g., 5G System) configuration (e.g., in UDM or other NF), the WTRU3/AF as the ESC for this network program ID and this target group.

At step 7-1, a WTRU1 may register with the (e.g., 5G) mobile network. At step 7-2, the WTRU1 may request an establishment of a PDU session, e.g., by sending a request to an AMF. The WTRU1 may, e.g., based on its configuration from user/customer or subscription profile, add a network program ID in the PDU session establishment request. At step 7-3, the AMF may select an SMF. At step 7-4, the AMF may forward the request of an establishment of a PDU session to the selected SMF.

At step 7-5, the SMF may determine that an ESC is registered to manage the PDU session. The determination may be based on any of parameters of the PDU session request such as network program ID if provided in request, DNN, S-NSSAI, source and destination addresses, etc. The SMF may obtain any of ESC identifier, network program ID and target group. This may be obtained from 5GS configuration (e.g., from local configuration, UDM, management plane configuration, etc.), using as a key the network program ID from a PDU session request and/or target group based on PDU session request parameters. As a non-limiting example, the SMF may determine that a session is part of a 5G LAN VN based on DNN and source/destination addresses, and the SMF may determine that this 5G LAN VN is associated with any of ESC, network program ID, and target group in 5GS configuration.

At step 7-6, the SMF may forward the PDU session request, including the network program ID, to the ESC WTRU3/AF. The SMF may maintain a list of PDU session IDs that are handled by the WTRU3/AF, associated with network program ID, which enables the SMF to forward future N4 messages associated with this PDU session ID, between the WTRU3/AF and the UPF/WTRU2.

At step 7-6, SMF may forward the PDU session request, including the network program ID, to the ESC WTRU3/AF. The SMF may maintain a list of PDU session IDs which are handled by the WTRU3/AF, associated with network program ID, which enables the SMF to forward future N4 messages associated with this PDU session ID, between the WTRU3/AF and the UPF/WTRU2.

At step 7-7, the WTRU3/AF may determine the traffic rules for the PDU session. For example, this decision may originate from a (e.g., SDN) controller program on the WTRU3/AF, configured by the user/customer. The WTRU3/AF may use the network program ID provided in step 7-6 to determine the traffic rules, e.g., in cases where the WTRU3/AF handles traffic rules related to multiple network programs.

At step 7-8, the WTRU3/AF may send an N4 information message including PCFP protocol IEs defining traffic rules for this session. The network program ID may be included in this message to facilitate verification by the SMF, of the validity of the message, e.g., including verifying that the traffic rules relate to traffic to/from the WTRU1 belonging to target group of the network program.

At step 7-9, the SMF may act as an intermediate SMF (I-SMF) for this session. The SMF may verify the N4 information message is valid.

At step 7-10, the SMF may forward N4 session establishment/update message, based on IEs extracted from the N4 information message of step 7-8, towards the UPF/WTRU2.

At step 7-11, the UPF/WTRU2 may configure traffic rules as specified in the N4 information message.

At step 7-12, a response message, from the UPF/WTRU2 may be sent back to the SMF. At step 7-13 a response message, from SMF may be sent back to the WTRU3/AF.

At step 7-14, a PDU session establishment accept message is sent back by the WTRU3/AF, then forwarded back to the WTRU1 through the SMF according to step and the AMF.

The WTRU3/AF may further communicate with the UPF/WTRU2, through the SMF. For example, the WTRU3/AF may modify the session traffic rules by sending a N4 information message updating the rules for a given PDU session ID. In another example, the UPF/WTRU2 may send PFCP IEs to the SMF, relayed by SMF to the WTRU3/AF, e.g., to report measurements or events related to the PDU session.

### Example of Network Program Deployment on WTRU

As a non-limiting example, for a deployment and operation of a network program on network programmable devices, the policy rules associated with a network program may be deployed on target devices (e.g., a WTRU, a UPF) using usual procedures, e.g., a configuration update procedure on a WTRU or using N4 control interface between an SMF and a UPF. The device (e.g., WTRU, UPF) may obtain network program IEs (e.g., network program deployment configuration IE, network program IE and network program configuration IE) along with policy rules. Alternatively, the device may retrieve network program IEs based on IE in policy rules (e.g., using an HTTP GET request with a URI built using a network program ID, such as “https://udm.example.com/network-program/<network-program-ID>”). The WTRU/UPF may (e.g., locally) install the policy rules and network program instance and may forward packets to/from the network program instance based on policy rules.

FIG. 8 is a sequence diagram illustrating a non-limiting example of the deployment and operation of a user network program on a WTRU. FIG. 8 provides a process example on how a WTRU may obtain a network program and associated information, and then installs and operates it. The process may rely on a configuration update procedure, which is depicted, as a non-limiting example, at registration time. It may also occur at other times (e.g., when the network program is provisioned in a (e.g., 5G) mobile network while the WTRU is registered).

At step 8-1, network programs and associated configuration may be provisioned in the (e.g., 5G) mobile network, along with network program related traffic rules. The (e.g., 5G) mobile network may translate the rules into URSP rules including a network program ID. The (e.g., 5G) mobile network may store URSP rules, network programs and configurations (e.g., including fields of network program deployment configuration IE, network program IE, network program configuration IE).

At step 8-2, the WTRU may request a registration with the mobile network. The WTRU may send a registration request to an AMF.

At step 8-3, the mobile network may proceed with a WTRU registration procedure, including the WTRU authentication.

At step 8-4, the AMF may send a registration accept message to the WTRU.

At step 8-5, the AMF may establish a WTRU policy association with PCF.

At step 8-6, a PCF may decide to update the WTRU configuration. As an example, the update may be decided because the WTRU belongs to a 5G LAN VN group or closed access group (CAG) that corresponds with the network program.

At step 8-7, to deliver WTRU policies, the PCF may send a Namf_Communication_NIN2MessageTransfer message including a WTRU policy container. The Namf_Communication_NIN2MessageTransfer message may include URSP rules with NPS. The message may include network program(s) and associated configuration.

At step 8-8, the WTRU may receive from the AMF the WTRU Policy container (WTRU policy information) received from the PCF. The container may include URSP rules with NPS and may include network program(s) and/or associated configuration.

At step 8-8b, in an alternative, the network program and/or associated configuration may be not provided directly along with policy (step 8-7 and step 8-8). In such case, as an example, the WTRU may extract a network program ID from the URSP rules and may determine the need to download network program and associated configuration from UDM/UDR. For example, the WTRU may prepare a uniform resource identifier (URI), e.g., using the network program ID (e.g., /network-program/<network-program-ID>) and may send an HTTPS GET request to UDM/UDR which returns the network program and/or associated configuration in its response.

At step 8-9, the WTRU may create a network program instance using the network program provided in step 8-8 or in step 8-8b. The WTRU provide its configuration (also obtained from step 8-8 or from step 8-8b), e.g., through a control API such as a P4 runtime API. The WTRU may (e.g., locally) maintain an association between this network program instance and its network program ID. The association may be used in step 8-14 to enable forwarding traffic to a network program instance, based on a network program ID in a URSP rule, and to select a URSP rule for traffic coming from a network program instance. In an alternative (not represented) the network program configuration information may be provided by an (e.g., external) SDN controller. Both methods may be used jointly, e.g., an initial configuration may be provided by WTRU, and an (e.g., SDN) controller may later update this configuration.

At step 10, the WRU may (e.g., locally) install WTRU policy rules on the WTRU, e.g., including URSP rules obtained from step 8-8 or step 8-8b. Some of the URSP rules may include a network program ID (e.g., as described in FIG. 5) corresponding to the network program instance created on step 8-9.

At steps 8-11, 8-12 and 8-13, the WTRU may trigger the completion of the WTRU delivery procedure and registration procedure. As an example, at step 8-11, the WTRU may send a result of the delivery of the WTRU policies to AMF. At step 8-12, the AMF may send a Namf_Communication_N1N2MessageNotify message to PCF. At step 8-13, the WTRU may send a registration complete message to the AMF.

At step 14, the WTRU may operates the network program instance as described herein in FIG. 4. Traffic may be forwarded through a network instance. The WTRU may process the packets as based on the selected traffic rule (e.g., create a PDU session for the first packet, forward over an existing PDU session, drop, etc.).

In an alternative, the network program instance may be a WTRU application: in some cases, network programs are distributed as WTRU applications, and WTRU traffic rules (e.g., based on URSP rules) may forward traffic to/from the application. For example, in a 5G LAN VN example, all traffic related to the 5G LAN VN should be forwarded by the WTRU to the WTRU application/network program instance. Deployment, configuration, and operation of a network program distributed as an application may follow the deployment, configuration and operation described in FIG. 8, with the difference that the network program may be distributed as a WTRU application (e.g., installed by user or by software deployment framework).

### Example of Network Program Deployment on UPF

FIG. 9 is a sequence diagram illustrating a non-limiting example of the deployment and operation of a user network program on a UPF. FIG. 9 provides a process example on how an UPF may obtain a network program and associated information, and then installs and operates it. The disclosed process may rely on an SMF to trigger network program installation on the UPF, over a control interface such as N4, e.g., using PFCP. In the following procedure example, a network program may be provided to the UPF during a N4 session establishment procedure (e.g., when a PDU session is created). The following procedure example may be also applied during a N4 session update procedure (e.g., when modifying a network program while a PDU session is in progress).

At step 9-0, network programs and associated configuration may be provisioned in a (e.g., 5G) mobile network, along with network program related traffic rules. The (e.g., 5G) mobile network may translate network program related traffic rules in suitable format for UPF (e.g., traffic rules to forward traffic to/from a network program instance). The (e.g., 5G) mobile network may store traffic rules, network programs and configuration information (e.g., including fields of network program deployment configuration IE, network program IE, network program configuration IE).

At step 9-0b, the (e.g., 5G) mobile network may configure the SMF (including with network program, related configuration, and traffic rules). The network program and related configuration information may be in part or entirely stored in another node (e.g., a UDM), such that the SMF may retrieve the network program and related configuration information (e.g., when installing traffic rules including a network program ID).

At step 9-1, as part of a PDU session creation or relocation procedure, the SMF may receive a trigger to install new rules on the UPF.

At step 9-2: the SMF may send to the UPF a N4 Session Establishment Request, including new IEs to provide traffic filters that include a network program ID as source or destination of a rule, e.g., a Network Program ID IE in create PDR and create FAR IEs. The request message may also include new IEs to create, update and remove network programs from the UPF, e.g., create/update/remove network program IEs.
A network program ID may be used for multiple PDU sessions (e.g., in an example, for all PDU sessions inside a given 5G LAN VN group). In this case, the same network program ID may be used by the SMF when installing rules for each PDU session. A create network program IE may be sent when installing rules for the first PDU session in this group, and the SMF may choose to omit this IE for subsequent PDU sessions, since the UPF already has the network program and its configuration.
New IEs in PCFCP protocol may be defined, for example, as:
   A Network Program ID (including one identifier), that may be used in different contexts:
      To match packets received from a (e.g., local) network program on the UPF: used within packet detection information IE within Create PDR IE within PFCP session establishment request and PFCP session modification request.
      To match packets forwarded towards a local network program on the UPF: used within forwarding parameters IE within create FAR IE within PFCP session establishment request and PFCP Session Modification Request.
   Create/update/remove network program IEs that may be used in PFCP association setup request and PFCP association update request. Upon reception, a UPF may respectively create a network program instance, modify its configuration, or reload modified code, or delete a network program instance.
      Create network program IE may include a network program deployment IE, network program IE, and/or network program configuration IE (as defined herein), or a reference/link to this information on UDM.
      Update network program IE may include a network program deployment IE, network program IE, and/or network program configuration IE, or a reference/link to this information on UDM.
      Remove network program may include a network program ID.

At step 9-3, the UPF may create a network program instance using the network program provided in step 9-2 and may provide its configuration (also obtained from step 9-2), e.g., through a control API such as a P4 runtime API. In an alternative not depicted, the network program may obtain its configuration from an (e.g., external) SDN controller.

At step 9-4, the UPF may install other policies, including some traffic rules with an NPS. As an example, a rule may include a PDR that includes a network program ID IE, which indicates that this traffic rule may match (e.g., only) traffic emitted by an instance of this network program ID. As an example, a traffic rule may include a FAR that may include a network program ID, which may indicate that when this rule is selected, packet/flow may be forwarded towards an instance of this network program ID.

At step 9-5, the UPF may send a N4 session establishment response to the SMF.

At step 9-6, as per PDU session establishment procedure, the SMF may interact with other network functions.

At step 9-7, the UPF may operate the network program instance as described herein in FIG. 4. Traffic may be forwarded through a network instance. The UPF may process the packets emitted by the network program instance based on the selected traffic rule (e.g., forward traffic over N6, N9, N19, drop traffic, etc.).

In an alternative, the network program instance may be an external network function. In some cases, network programs, instead of being configured on a UPF, may be configured in a separate network function. The (e.g., 5G) mobile network operator may ensure that relevant packets processed by the UPF are processed through the network program NF, e.g., using NSH encapsulation.

### Representative Provisioning of a Network Program

An AF or a WTRU may provision network programs and associated configuration information in a (e.g., 5G) mobile network system, e.g., using a NEF API. The provisioned information may include any of a network program deployment configuration IE, a network program IE, a network program configuration IE, and a network program traffic rules IE. The (e.g., 5G) mobile network may select target WTRUs and/or one or more SMFs and/or one or more UPFs where network program should be deployed. As an example, deployment may use a target type IE provided by the AF/WTRU (as part of the network program deployment configuration IE), which may be any of a 5G LAN VN group ID, a PNI-NPN identifier, a SNPN identifier, a WTRU ID, and a group ID. The (e.g., 5G) mobile network may define URSP rules and/or PDR records based on network program related traffic rules. The (e.g., 5G) mobile network may store network program IEs, e.g., in UDM/UDR using network program ID as key. The (e.g., 5G) mobile network may deploy the network programs on selected WTRUs and SMFs/UPFs, e.g., as described in FIG. 8 and in FIG. 9. The (e.g., 5G) mobile network operator may provide (e.g., through NEF), to the AF/WTRU, the means for an (e.g., external) SDN controller to discover the control interface to the network program instances. For example, the means for an (e.g., external) SDN controller may include a list of IP addresses or FQDNs corresponding to each network instance. The (e.g., 5G) mobile network operator may configure the FQDNs of network instances into the DNS system in this last case.

Network programs may be deployed on WTRUs, UPFs or a combination of both. In simple 5G LAN VN use case, e.g., where (e.g., only regular) WTRUs are members, network programs may be deployed on one or more UPFs that are serving this 5G LAN VN group. In 5G LAN VN use cases where some of the member WTRUs may be used as gateways for member devices, the WTRU/gateway devices may also host a network program. In PIN or residential networks, a WTRU/gateway or a UPF collocated with gNodeB may host a network program.

As a non-limiting example, NEF API for network program provisioning may be a representational state transfer (REST) API. A REST API may enable:
creating, updating, and deleting resources such as “/network-program/<network-program-ID>,”
using the body of the resource to store deployment configuration parameters, and using resources to store a network program (“/network-program/<network-program-ID>/program”),
associated configuration (“/network-program/<network-program-ID>/configuration”) and traffic rules (“/network-program/<network-program-ID>/rules”).

Deployment of network programs may alternatively be performed in another manner, e.g., by the (e.g., 5G) mobile network operator through a network management system, or through another type of API.

### Example of a Method for Operating a User Network Program on a WTRU or on a Base Station.

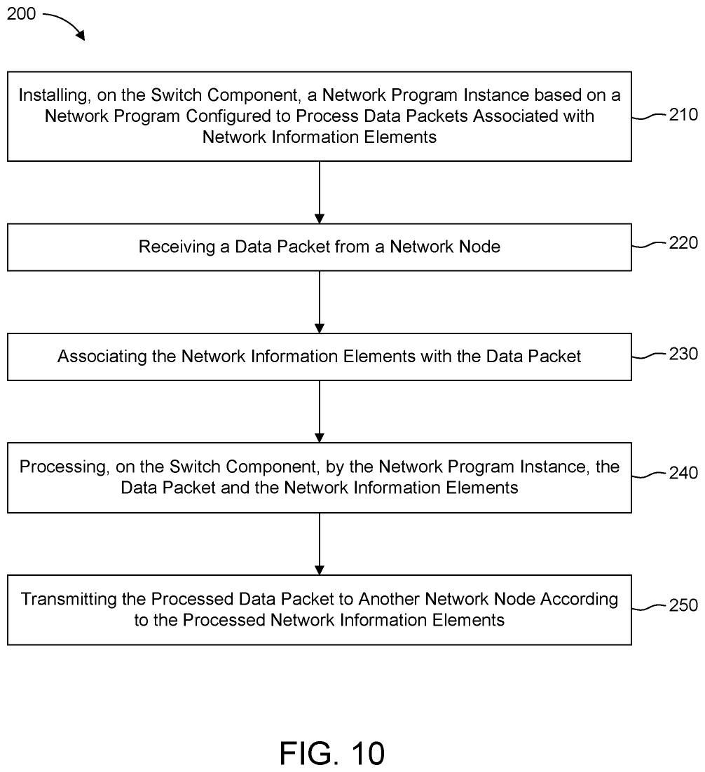

Referring to FIG. 10, a flow chart illustrating an example of a method 200 for operating a user network program on a WTRU or on a Base Station is depicted. The method may be implemented by a wireless transmit/receive unit, WTRU or by a base station, collocated with a switch component. In an embodiment, the user network program may be deployed on a UPF. The method 200, may comprise the following steps. The method is not limited to be deployed by a WTRU such that the terms “WTRU” and “base station” may be used interchangeably herein.

At step 210, the WTRU, or the base station, may install, on the collocated witch component, a network program instance based on a network program configured to process data packets associated with network information elements. The network program instance may be configured via external parameter provisioning. The switch component may be a virtual switch on the WTRU, or the switch component may be connected to the WTRU. The network information elements may comprise metadata network information elements of the network, wherein the metadata network information elements may be encapsulated in a header of the data packets. The network program may be a (e.g., compiled) P4 program.

At step 220, the WTRU may receive a data packet from a network node.

At step 230, the WTRU may associate the network information elements with the data packet. The network information elements associated with the data packet may include PDU session related network information elements. The PDU session related network information elements may include any of a single network slice selection assistance information, an application identifier, a PDU session type, a data network name, domain descriptors, a PDU session identifier, and a mobile network level of service.

At step 240, the network program instance, deployed on the switch component, may process the data packet and the network information elements. The processing, by the network program instance, of the data packet may be based on the network information elements associated with the packet.

At step 250, the WTRU may transmit the processed data packet to another network node according to the processed network information elements. The network information elements may be updated by the network program instance.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS.. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 25 U.S.C. § 112, ¶ 6 or means-plus-function claim format, and any claim without the terms “means for” is not so intended.

1. A method, implemented by a wireless transmit/receive unit (WTRU) collocated with a switch component, the method comprising:
installing, on the switch component, a network program instance based on a network program configured to process data packets associated with mobile network information elements;
installing, on the WTRU, a traffic rule associated with the network program instance;
receiving a data packet from a network node;
based on the traffic rule:
(i) associating the mobile network information elements with the data packet; and
(ii) transmitting the data packet and the associated mobile network information elements toward the network program instance;
processing, on the switch component, by the network program instance, the data packet and the mobile network information elements; and
transmitting the processed data packet to another network node according to the processed mobile network information elements.

2. The method of claim 1, wherein the network program instance is configured via external parameter provisioning.

3. The method of claim 1, wherein the switch component is a virtual switch on the WTRU.

4. (canceled)

5. The method of claim 1, wherein the mobile network information elements associated with the data packet include packet data unit (PDU) session related information elements.

6. The method of claim 5, wherein the PDU session related information elements include any of a single network slice selection assistance information, an application identifier, a PDU session type, a data network name, domain descriptors, a PDU session identifier, a mobile network level of service.

7. The method of claim 1, wherein the processing, by the network program instance, of the data packet is based on the mobile network information elements associated with the data packet.

8. The method of claim 1, wherein the mobile network information elements comprise metadata mobile network information elements of the network.

9-11. (canceled)

12. An apparatus, including any of a processor and memory, configured to:
install, on a switch component, a network program instance based on a network program configured to process data packets associated with mobile network information elements;
install, on a wireless transmit/receive unit (WTRU), a traffic rule associated with the network program instance;
receive a data packet from a network node;
based on the traffic rule:
(i) associate the mobile network information elements with the data packet;
(ii) transmit the data packet and the associated mobile network information elements toward the network program instance;
process, on the switch component, by the network program instance, the data packet and the mobile network information elements; and
transmit the processed data packet to another network node according to the processed mobile network information elements.

13. The apparatus of claim 12, wherein the network program instance is configured via external parameter provisioning.

14. The apparatus of claim 12, wherein the switch component is a virtual switch on the apparatus.

15. (canceled)

16. The apparatus of claim 11, wherein the mobile network information elements associated with the data packet include packet data unit (PDU) session related information elements.

17. The apparatus of claim 16, wherein the related information elements include any of single network slice selection assistance information, application identifier, PDU session type, data network name, domain descriptors, PDU session identifier, mobile network level of service.

18. The apparatus of claim 12, wherein processing, by the network program instance, of the data packet is based on the mobile network information elements associated with the data packet.

19. The apparatus of claim 12, wherein the mobile network information elements comprise metadata mobile network information elements of the network.

20-24. (canceled)

25. The method of claim 1, wherein the processed mobile network information elements comprise information indicating any of a selection of a traffic rule or a traffic rule action.

26. The method of claim 1, wherein processing the data packet and the mobile network information elements comprises determining the value of any mobile network information elements.

27. The method of claim 1, wherein the processed mobile network information elements associated with the processed data packet include packet data unit (PDU) session related information elements.

28. The apparatus of claim 11, wherein the processed mobile network information elements comprise information indicating any of a selection of a traffic rule or a traffic rule action.

29. The apparatus of claim 11, wherein processing the data packet and the mobile network information elements comprise determining the value of any mobile network information elements.

30. The apparatus of claim 11, wherein the processed mobile network information elements associated with the processed data packet include packet data unit (PDU) session related information elements.
